(19) United States
(12) Patent Application Publication
(10) Pub. No.: US 2020/0166161 A1
(43) Pub. Date: May 28, 2020

(54) JOINED COMPONENT THROUGH WHICH PROCESS FLUID PASSES IN SEMICONDUCTOR MANUFACTURING PROCESS OR DISPLAY MANUFACTURING PROCESS

(71) Applicant: POINT ENGINEERING CO., LTD., Asan (KR)

(72) Inventor: Bum Mo AHN, Suwon (KR)

(21) Appl. No.: 16/685,906

(22) Filed: Nov. 15, 2019

(30) Foreign Application Priority Data
Nov. 28, 2018 (KR) 10-2018-0150041

(51) Int. Cl. F16L 13/02; F16L 39/00

(52) U.S. Cl. CPC F16L 13/02; F16L 39/00

(57) ABSTRACT

The present invention relates to a joined component used in a semiconductor manufacturing process or a display manufacturing process, in which the joined component is formed by welding parent members by friction stir welding.

### CROSS REFERENCE TO RELATED APPLICATION

The present application claims priority to Korean Patent Application No. 10-2018-0150041, filed Nov. 28, 2018, the entire contents of which is incorporated herein for all purposes by this reference.

### BACKGROUND OF THE INVENTION

### Field of the Invention

The present invention relates to a joined component that is formed by friction stir welding and through which a process fluid passes in a semiconductor manufacturing process or a display manufacturing process.

### Description of the Related Art

As a technique for depositing a thin film on a semiconductor substrate or glass, chemical vapor deposition (CVD) or atomic layer deposition (ALD), which are thin-film deposition techniques based on chemical reaction, is used.

Equipment for performing thin-film deposition, such as CVD or ALD, is used to manufacture semiconductor devices. Such thin-film deposition equipment usually includes a showerhead provided inside a chamber to supply a reaction process fluid required for depositing a thin film on a wafer. The showerhead serves to spray the reaction process fluid onto the wafer in the proper distribution range required for thin film deposition.

One example of the showerhead is disclosed in Korean Patent No. 10-0769522 (hereinafter, referred to as “Patent Document 1”).

In Patent document 1, a showerhead is configured to spray a reaction gas introduced into a main hole and an auxiliary hole onto the wafer surface through a guide groove.

On the other hand, inside a vacuum chamber used for display manufacturing, a diffuser may be provided to uniformly spray gas onto glass. A display is a non-light emitting device in which liquid crystals are injected between an array substrate and a color filter substrate to obtain an image effect by using the characteristics thereof. The array substrate and the color filter substrate may be manufactured in such a manner that a thin film is repeatedly deposited onto a transparent substrate made of glass or the like, and patterning and etching are followed. In this case, when a reaction material and a source material in a gaseous phase are introduced into the vacuum chamber in a deposition process, introduced gases are passed through the diffuser and deposited onto glass installed on a susceptor to form a film.

One example of the diffuser is disclosed in Korean Patent No. 10-1352923 (hereinafter, referred to as “Patent Document 2”).

In Patent Document 2, a diffuser is disposed in an upper region in the chamber to provide a deposition material onto the surface of a glass substrate.

Fluid passing members, such as the showerhead of Patent Document 1 and the diffuser of Patent Document 2, spray a process fluid onto a wafer or glass to form a film. A process fluid to be sprayed from a passing member is injected thereinto through one supply line and is sprayed through a hole provided in the fluid passing member. The spraying of the process fluid may involve the use of a mixture of several process fluids to allow the mixture to react in a plasma state. The process fluids may be injected into the fluid passing member in an already mixed state and introduced into a fluid hole thereof.

However, in the fluid passing member, when the already mixed process fluids are introduced into the fluid hole of the fluid passing member, the process fluids may react inside the fluid passing member to cause an undesired chemical reaction. The process fluid sprayed from the fluid passing member has to react after a phase transition to a plasma state to form a film on the wafer or glass. However, due to the fact that a mixed process fluid in which several process fluids are already mixed is introduced into the fluid hole, there may arise a problem in that an undesired chemical reaction may occur due to the process fluids reacting inside the fluid passing member.

As described above, in the fluid passing member in the related art, the mixed process fluid may be introduced into the fluid hole of the fluid passing member and tend to react inside the fluid passing member, causing an undesired chemical reaction to occur. In order to prevent this, as shown in FIGS. 1A and 18, formation of fluid holes for spraying different process fluids into a fluid passing member may be considered. As one example of a method of manufacturing a fluid passing member having fluid holes for spraying different process fluids, a method of welding or brazing a metal filler material in a molten state may be used.

FIGS. 1A and 1B are views showing a technology underlying the present invention, in which a portion of a fluid passing member manufactured by welding or brazing a metal filler material in a molten state is shown enlarged. FIG. 1A is a view showing parent members 1 in a state before the method of welding or brazing the metal filler material in a molten state is used. FIG. 1B is a view showing a portion of a fluid passing member manufactured by the method of welding or brazing the metal filler material in the molten state.

As shown in FIG. 1A, grooves 2 may be formed in opposed contact surfaces of the respective parent members 1 in an opposed relationship to form second fluid holes 4b. The second fluid holes 4b may provide passages into which a second process fluid is introduced from a second supply line (not shown). The parent members 1 in which the grooves 2 are formed may be welded or brazed by using the molten metal filler material. Then, first fluid holes 4a may be formed by use of a perforation method in regions in which no second fluid holes 4b are formed. The first fluid holes 4a may provide passages into which a first process fluid is introduced from a first supply line (not shown). The second fluid holes 4b may be formed in communication with the grooves 2.

However, in the above technology, when the respective process fluids are injected into the first and second fluid holes 4a and 4b, the metal filler material of a weld joint or braze joint 20 formed between the parent members 1, may be exposed to the process fluids, thus leading to increased corrosion.

In detail, the above technology is characterized in that the weld joint or braze joint 20 also exists at inner surfaces of the fluid holes 4a and 4b. Due to this, there may arise a problem in that the weld joint or braze joint 20 existing at the inner surfaces of the fluid holes may be exposed due to the process fluids passing through the respective fluid holes, causing corrosion.

The corrosion occurring on the inner surfaces of the fluid holes as described above may cause a problem that when the process fluids are sprayed from the fluid passing member through the fluid holes, particles which may be generated due to corrosion may be sprayed together with the process fluids. This not only adversely affects formation of a film on a wafer or glass but may also result in production of defective products.

As such, according to the technology underlying the present invention, a conventional welding method has disadvantages that may cause various problems.

The foregoing is intended merely to aid in the understanding of the background of the present invention, and is not intended to mean that the present invention falls within the purview of the related art that is already known to those skilled in the art.

### DOCUMENTS OF RELATED ART

(Patent document 1) Korean Patent No. 10-0769522
(Patent document 2) Korean Patent No. 10-1352923

### SUMMARY OF THE INVENTION

Accordingly, the present invention has been made keeping in mind the above problems occurring in the related art, and an objective of the present invention is to provide a joined component through which a process fluid passes in a semiconductor manufacturing process of a display manufacturing process, the joined component being manufactured by friction stir welding in a structure that supplies different process fluids, thus enabling an efficient thin film forming process.

In order to achieve the above objective, according to one aspect of the present invention, there is provided a joined component through which a process fluid passes in a semiconductor manufacturing process or a display manufacturing process, the joined component being formed by welding at least two parent members by friction stir welding, and including: a first fluid hole vertically passing through the parent members and providing a passage through which a first process fluid passes; and a second fluid hole being in communication with a first hollow channel formed inside the joined component, and providing a passage through which a second process fluid passes, wherein a weld zone formed by friction stir welding is formed to remove at least a part of a horizontal interface between the first and second fluid holes, and the first process fluid is introduced into the first fluid hole and the second process fluid is introduced into the second fluid hole, such that the first and second fluid holes respectively supply different process fluids separately.

According to another aspect of the present invention, there is provided a joined component through which a process fluid passes in a semiconductor manufacturing process or a display manufacturing process, the joined component being formed by welding at least two parent members by friction stir welding, and including: a first fluid hole vertically passing through an overlap portion where weld zones formed by friction stir welding at least partially overlap each other, and providing a passage through which a first process fluid passes; and a second fluid hole being in communication with a first hollow channel formed inside the joined component, and providing a passage through which a second process fluid passes, wherein a weld zone formed by friction stir welding is formed to remove at least a part of a horizontal interface between the first and second fluid holes, and the first process fluid is introduced into the first fluid hole and the second process fluid is introduced into the second fluid hole, such that the first and second fluid holes respectively supply different process fluids separately.

According to still another aspect of the present invention, there is provided a joined component through which a process fluid passes in a semiconductor manufacturing process or a display manufacturing process, the joined component being formed by welding at least two parent members by friction stir welding, and including: a first fluid hole passing through the parent members in a weld zone formed by friction stir welding, and providing a passage through which a first process fluid passes; and a second fluid hole being in communication with a first hollow channel formed inside the joined component, and providing a passage through which a second process fluid passes.

In an embodiment of the present invention, the joined component may further include a second hollow channel formed inside the joined component and including a temperature control means.

In an embodiment of the present invention, the temperature control means may be a fluid or a heat wire.

In an embodiment of the present invention, the joined component may be provided in etching equipment, cleaning equipment, heat treatment equipment, ion implantation equipment, sputtering equipment, or CVD equipment.

In an embodiment of the present invention, the first fluid hole may be provided as multiple first fluid holes that are arranged at a spaced apart relationship at an interval of equal to or greater than 3 mm to equal to or less than 15 mm, and the second fluid hole may be provided as multiple second fluid holes that are arranged at a spaced apart relationship at an interval of equal to or greater than 3 mm to equal to or less than 15 mm.

As described above, the joined component used in the semiconductor manufacturing process or the display manufacturing process according to the present invention is manufactured by friction stir welding in a structure capable of spraying different process fluids to enable an efficient thin film forming process, and capable of reducing the risk of corrosion to reduce the rate of product defects.

### BRIEF DESCRIPTION OF THE DRAWINGS

The above and other objectives, features, and other advantages of the present invention will be more clearly understood from the following detailed description when taken in conjunction with the accompanying drawings, in which:

FIGS. 1A to 18 are views schematically showing a technology underlying the present invention;

FIGS. 2A and 2B are views schematically showing a first embodiment of the present invention, formed by friction stir welding which is a technical feature of the present invention;

FIGS. 3A and 3B are views showing a joined component used in a semiconductor manufacturing process or a display manufacturing process according to the first embodiment of the present invention;

FIGS. 4A to 4C are views schematically showing a manufacturing process of FIG. 3;

FIGS. 5A to 5C are views schematically showing a manufacturing process of a modification of the first embodiment;

FIG. 6 is a view schematically showing semiconductor manufacturing process equipment or display manufacturing process equipment;

FIG. 7 is an enlarged view showing a joined component used in a semiconductor manufacturing process or a display manufacturing process, which is provided in FIG. 6;

FIGS. 8A and 88 are views schematically showing a second embodiment of the present invention, formed by friction stir welding which is a technical feature of the present invention;

FIGS. 9A and 98 are views showing a joined component used in a semiconductor manufacturing process or a display manufacturing process according to a second embodiment of the present invention;

FIGS. 10A to 10D-2 are views schematically showing a manufacturing process of FIGS. 9A and 98;

FIGS. 11A to 11D-2 are views showing a first modification of the second embodiment of the present invention;

FIGS. 12A to 12D-2 are views showing a second modification of the second embodiment of the present invention;

FIGS. 13A to 13D-2 are views showing a third modification of the second embodiment of the present invention;

FIGS. 14A to 14E are views showing a fourth modification of the second embodiment of the present invention; and

FIG. 15 is a view schematically showing semiconductor manufacturing process equipment or display manufacturing process equipment.

### DETAILED DESCRIPTION OF THE INVENTION

The following description merely exemplifies the principle of the present invention. Thus, although not explicitly described or shown in this disclosure, various devices in which the principle of the present invention is implemented and which are encompassed in the concept or scope of the present invention can be invented by one of ordinary skill in the art. It should be appreciated that all the conditional terms enumerated herein and embodiments are clearly intended only for a better understanding of the concept of the present invention, and the present invention is not limited to the particularly described embodiments and statuses.

The forgoing objectives, advantages, and features of invention will become more readily apparent from the following detailed description taken in conjunction with the accompanying drawings, and accordingly, one of ordinary skill in the art may easily practice the embodiment of the present invention.

Embodiments are described herein with reference to sectional and/or perspective illustrations that are schematic illustrations of idealized embodiments. Also, for convenience of understanding of the elements, in the figures, thicknesses of members and regions and diameters of holes may be exaggerated to be large for clarity of illustration. As such, variations from the shapes of the illustrations as a result, for example, of manufacturing techniques and/or tolerances, are to be expected. In addition, the number of holes shown in the drawings is by way of example only. Thus, embodiments should not be construed as limited to the particular shapes illustrated herein but are to include deviations in shapes that result, for example, from manufacturing.

Wherever possible, the same reference numerals will be used throughout different embodiments and the description to refer to the same or like elements or parts having like functions throughout. Furthermore, the configuration and operation already described in other embodiments will be omitted for convenience of the description.

Hereinbelow, exemplary embodiments of the present invention will be described in detail with reference to the accompanying drawings.

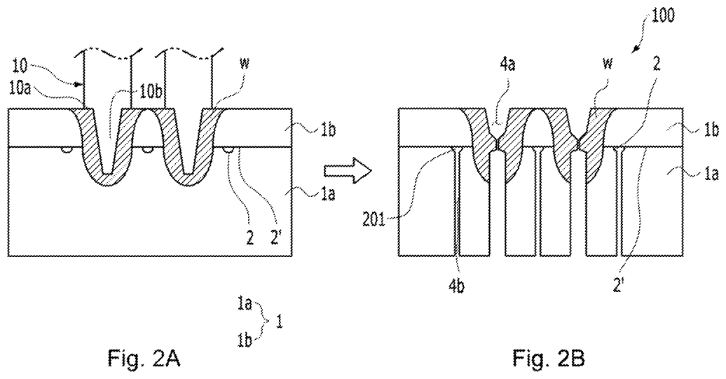

FIGS. 2A and 2B are views schematically showing an enlarged part of a joined component 100 used in a semiconductor manufacturing process or a display manufacturing process (hereinafter referred to as a “joined component”) and formed by friction stir welding, which is a technical feature of the present invention. As shown in FIG. 2A, at least two parent members 1 may be welded by friction stir welding. FIGS. 2A and 2B show, as an example, that at least two parent members 1 are stacked on top of each other and welded by friction stir welding, but the shape of the parent members 1 are not limited thereto.

As shown in FIGS. 2A and 2B, the joined component 100 may include at least two parent members 1, a first fluid hole 4a through which a first process fluid passes, and a second fluid hole 4b through which a second process fluid passes.

As shown in FIGS. 2A and 2B, when the parent members 1 are stacked on top of each other and welded, the parent members 1 may be comprised of a first parent member 1a located at a lower position on the drawings, and a second parent member 1b located on top of the first parent member 1a.

As shown in FIG. 2A, the first parent member 1a and the second parent member 1b may be welded by friction stir welding. Friction stir welding may be performed along a contact junction formed on at least a part of each interface between the parent members 1 to form a weld zone w. At least a part, other than the contact junction where the weld zone w is formed, may remain unwelded.

Friction stir welding is a process that joins workpieces without melting the workpiece material. Friction stir welding can reduce generation of defects such as pores, solidification cracks, and residual stresses due to a phase change from liquid to solid, which is advantageous over conventional welding or brazing. When friction stir welding is performed along the contact junction formed at each interface between the parent members 1, a pin 10b is brought into friction contact with the parent members and generates heat. In this state, a shoulder 10a coupled to an upper portion of the pin 10b is brought into contact with the parent members and expands the heating area. Then, the pin 10b or the parent members 1 are moved to cause the material under the pin to plastically flow to form a friction stir welding nugget zone. The nugget zone is a region where recovery and recrystallization occurs due to high heat and the amount of deformation, also called a dynamic recrystallization zone.

Unlike general welding in which melting occurs due to heat, the nugget zone is formed through dynamic recrystallization of the material which occurs in a solid state below the melting point due to frictional heat and stirring. The diameter of the nugget zone is larger than that of the pin 10b while being smaller than that of the shoulder 10a. The size of the nugget zone depends on the speed of rotation of a welding tool 10 including the pin 10b and the shoulder 10a. As the speed of rotation increases, the size of the nugget zone decreases. However, when the speed of rotation is too high, the shape of crystal grains may be incomplete, and defects may occur at the incomplete portion. In the vicinity of the nugget zone where the parent members 1 are mixed during friction stir welding, a thermo-mechanically affected zone (TMAZ) surrounding the nugget zone is formed, and a heat affected zone (HAZ) surrounding the thermo-mechanically affected zone is formed.

The thermo-mechanically affected zone is a region where partial recrystallization occurs due to plastic deformation caused by friction at a contact surface where the shoulder 10a of the welding tool 10 is brought into contact with the parent members, and where thermal deformation due to friction and mechanical deformation due to the shoulder 10a simultaneously occur. In the thermo-mechanically affected zone, crystals softened due to excessive plastic flow and deformation of the material may be distributed at an angle.

The heat affected zone is a region more affected by heat than the thermo-mechanically affected zone, in which slant crystal grains are present and many pores are present.

The weld zone w formed by friction stir welding may be a region including the nugget zone, the thermo-mechanically affected zone, and the heat affected zone. Preferably, the weld zone w may be a region where the nugget zone and the thermo-mechanically affected zone are formed below each interface between the parent members 1, or a region where the nugget zone is formed below each interface between the parent members 1. Therefore, the first fluid hole 4a passing through the weld zone w which will be described later may be formed within the range of the weld zone w. Preferably, the first fluid hole 4a passing through the weld zone w may be formed within the range of the nugget zone and the range of the thermo-mechanically affected zone, and more preferably, may be formed within the range of the nugget zone.

The material of the parent members 1 may be any material enabling that: i) frictional heat is generated by friction between the pin 10b rotating at a high speed and the parent members 1, ii) the parent members 1 around the pin 10b are softened by the frictional heat, and iii) the parent members 1 are forcibly mixed together by plastic flow of the parent members 1 occurring on the joined surfaces by a stirring action of the pin 10b. The material of the parent members 1 constituting a joined component 100 may be made of at least one of aluminum, aluminum alloy, titanium, titanium alloy, magnesium, magnesium alloy, carbon steel, and stainless steel. The material of the parent members 1 may be composed of at least one of non-ferrous metal including aluminum, aluminum alloys, titanium, titanium alloys, magnesium, magnesium alloys, and the like, and carbon steel, and stainless steel, but is not limited thereto.

When at least two parent members 1 are welded by friction stir welding, the at least two parent members 1 may be made of dissimilar metal materials. For example, when the first parent member 1a is made of aluminum, which is one of the above materials, the second parent member 1b may be made of stainless steel. On the other hand, the parent members 1 may be made of the same metal material. For example, when the first parent member 1a is made of aluminum, the second parent member 1b may also be made of aluminum, and when the first parent member 1a is stainless steel, the second parent member 1b may also be made of stainless steel. Friction stir welding is a solid-state joining process, and thus members having different melting points can be stably joined. In other words, it is possible to stably join dissimilar metal materials. In particular, the nugget zone included in the weld zone w is a region in which dynamic recrystallization occurs, and thus the nugget zone has a structure resistant to external vibrations and impacts. Furthermore, the thermo-mechanically affected zone included in the weld zone w is a region in which the parent members 1 are mixed and joined, and thus thermo-mechanically affected zone has a structure resistant to external vibrations and impacts. Unlike other welding processes such as a welding process of joining a metal filler material in a molten state, a brazing process, and the like, friction stir welding does not require a heat source, a welding rod, a filler metal, and the like, and thus no harmful rays or harmful substances are emitted during welding. Furthermore, dynamic recombination occurs, and thus it is possible to prevent solidification cracks which may occur in conventional welding, and there is little deformation and thus mechanical properties are excellent.

According to the present invention, it is ensured that a weld zone w having such a high strength and weldability removes at least a part of a horizontal interface between the first and second fluid holes 4a and 4b. This therefore prevents a phenomenon where the first process fluid passing through the first fluid hole 4a and the second process fluid passing through the second fluid hole 4b move along horizontal interfaces between the parent members 1 and are mixed inside the joined component 100, and the mixed first and second process fluids react with each other to cause an undesired chemical reaction to occur. It is further ensured that the process fluid passing through the first fluid hole 4a is prevented from penetrating along the horizontal interface to reach the second fluid hole 4b, and the second process fluid passing through the second fluid hole 4b is prevented from penetrating along the horizontal interface to reach the first fluid hole 4a.

As shown in FIG. 2A, a groove 2 may be formed in at least one of opposed contact surfaces of the parent members 1. Due to the formation of the groove 2 formed in at least one of the opposed contact surfaces of the parent members 1, a second supply line for supplying the second process fluid is connected to the second fluid hole 4b which will be described later through the groove. FIGS. 2A and 2B show, as an example, that a first groove 2 is formed in the first parent member 1a. For convenience, the same reference numerals are given to the groove 2 and the first groove 2.

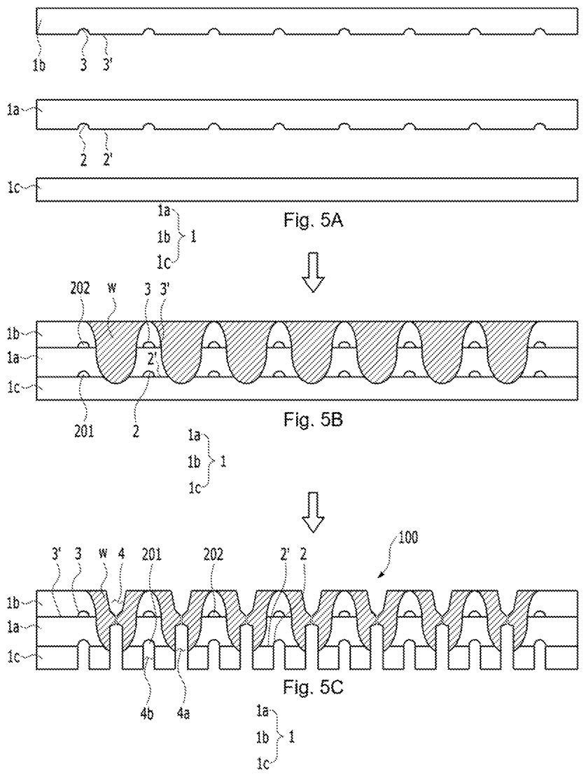

In addition, due to the formation of the groove 2 formed in at least one of the opposed contact surfaces of the parent members 1, when at least three parent members 1 are provided, a hollow channel including a temperature control means may be formed inside the joined component 100. A detailed description thereof will be described later in a modification of a first embodiment of the present invention with reference to FIGS. 5A to 5C.

When the groove 2 is formed in at least one of the contact surfaces of the parent members 1, there may be provided a groove region in which the groove 2 is formed and a non-groove region 2′ in which the groove 2 is not formed. For example, when the first groove 2 is formed in the contact surface of the first parent member 1a, the first parent member 1a may include a first groove region and a first non-groove region 2′. In this case, the first groove region of the first parent member 1a and a first region of the second parent member 1b, which are in an opposed relationship, may not be welded, while the first non-groove region 2′ of the first parent member 1a and a second region of the second parent member 1b, which are in an opposed relationship, may be welded by friction stir welding to form a weld zone w. In this case, friction stir welding may be performed along a contact junction formed on at least a part of an interface between the first non-groove region 2′ of the first parent member 1a and the second region of the second parent member 1b, and a weld zone W is formed thereby.

In FIGS. 2A and 2B, one groove 2 is provided between adjacent weld zones w. However, two or more grooves may be provided therebetween, and the number of grooves is limited in the embodiment of the present invention.

As shown in FIG. 28, the joined component 100 may include the first fluid hole 4a passing through the parent members 1 in a weld zone w formed by friction stir welding, and providing a passage through which the first process fluid passes, and the second fluid hole 4b being in communication with a first hollow channel 201 formed inside the joined component 100, and providing a passage through which the second process fluid passes.

In the weld zone w, the first fluid hole 4a providing a passage through which the first process fluid passes is formed by passing through the parent members 1. The first fluid hole 4a may be formed to have a different width for each position where the first process fluid passes. In FIG. 2B, an upper portion of the first fluid hole 4a may be an inlet portion into which the first process fluid supplied from the first supply line is introduced. The width of the inlet portion may be arbitrarily determined. A narrow portion may extend from a lower end of the inlet portion, with a width narrower than the width of the inlet portion. The first process fluid introduced into the inlet portion may be increased in flow velocity while passing through the narrow portion narrower in the width than the inlet portion. The first process fluid flowing at an increased flow velocity through the narrow portion may be rapidly sprayed onto a wafer or glass. This ensures that efficiency of a semiconductor manufacturing process or a display manufacturing process is increased. Such a shape of the first fluid hole 4a is to increase the flow velocity of the first process fluid to thereby perform a highly efficient manufacturing process, and the present invention is not limited thereto.

The first fluid hole 4a may be provided as multiple first fluid holes 4a that are arranged in a spaced apart relationship at an interval of equal to or greater than 3 mm to equal to or less than 15 mm. The first fluid holes 4a may be formed to appropriately maintain the arrangement interval at an interval of equal to or greater than 3 am to equal to or less than 15 mm, to facilitate provision of the second fluid hole 4b providing a passage through which the second process fluid passes. In detail, the joined component 100 according to the present invention may be configured such that the first and second process fluids are injected separately thereinto and sprayed separately therefrom. To this end, the first and second fluid holes 4a and 4b providing passages through which the first and second process fluids pass, respectively, have to be formed separately in the joined component 100. Herein, as an example, the joined component 100 may have a structure in which the second fluid hole 4b is provided between each of the first fluid holes 4a. In this case, when the interval between the first fluid holes 4a is too small, it may be difficult to provide the second fluid hole 4b therebetween. On the contrary, when the interval between the first fluid holes 4a is too large, the number of the first fluid holes 4a that can be provided in a first fluid hole existence region where the multiple first fluid holes 4a exist may be relatively small. In this case, the amount of the first process fluid introduced into the first fluid holes 4a may be substantially smaller than the amount of the first process fluid supplied to the first fluid holes 4a. This may cause a problem that the spraying amount of the first process fluid is smaller than the supply amount thereof, thus resulting in spraying efficiency being reduced. This is why it is preferable that the interval between the first fluid holes 4a is equal to or greater than 3 mm to equal to or less than 15 mm.

The second fluid hole 4b may be formed in communication with the first groove 2. Due to this configuration, the second supply line for supplying the second process fluid is connected to the second fluid hole 4b through the first groove 2 such that the second process fluid is introduced into the second fluid hole 4b. The second fluid hole 4b may be formed by passing through a lower portion of the first parent member 1a, in communication with the first groove 2. Due to this configuration, the joined component 100 sprays the second process fluid introduced into the second fluid hole 4b.

In FIGS. 2A and 2B, the second fluid hole 4b is smaller in width than the first groove 2. However, the width and shape of the second fluid hole 4b is not limited thereto and may have the same width as the first groove 2. Furthermore, the second fluid hole 4b may be formed in the same shape as the first fluid holes 4a shown as an example in the drawings of the present invention. However, the second fluid hole 4b may be formed in any shape as long as being in communication with the first hollow channel 201 and passing through the lower portion of the first parent member 1a.

The groove 2 may be formed in at least one of the contact surfaces of the parent members 1 to define the first hollow channel 201 formed inside the joined component 100. In the present invention, the groove 2 is formed in the first parent member 1a to provide the first groove 2. Therefore, the second fluid hole 4b being in communication with the first groove 2 of the first parent member 1a may be formed in communication with the first hollow channel 201 formed inside the joined component 100.

The second fluid hole 4b may be provided as multiple second fluid holes 4b that are arranged in a spaced apart relationship at an interval of equal to or greater than 3 mm to equal to or less than 15 mm. The second fluid holes 4b may be formed to appropriately maintain the arrangement interval at an interval of equal to or greater than 3 mm to equal to or less than 15 mm, to be easily provided in the joined component 100. In detail, the joined component 100 according to the present invention may be configured such that the first and second process fluids are injected separately thereinto and sprayed separately therefrom. To this end, the first and second fluid holes 4a and 4b providing passages through which the first and second process fluids pass, respectively, have to be formed separately in the joined component 100. Herein, as an example, the joined component 100 may have a structure in which the second fluid holes 4b are provided between the first fluid holes 4a. In this case, when the interval between the second fluid holes 4b is too small, it may be difficult to provide each of the second fluid holes 4b within the range defined by the interval between the first fluid holes 4a. On the contrary, when the interval between the second fluid holes 4b is too large, the number of the second fluid holes 4b that can be provided in a second fluid hole existence region where the multiple second fluid holes 4b exist may be relatively small. In this case, the amount of the second process fluid introduced into the second fluid holes 4b may be substantially smaller than the amount of the second process fluid supplied to the second fluid holes 4b. This may cause a problem that the spraying amount of the second process fluid is smaller than the supply amount thereof, thus resulting in spraying efficiency being reduced. This is why it is preferable that the interval between the second fluid holes 4b is equal to or greater than 3 mm to equal to or less than 15 mm.

In the joined component 100 according to the present invention having the above-described configuration, the first fluid holes 4a are formed in weld zones w by passing through the parent members 1, and the second fluid holes 4b are formed in communication with first hollow channels 201. This ensures that the first process fluid and the second process fluid are separately injected into the joined component 100. In addition, it is ensured that the process fluids (first and second process fluids) separately respectively injected into the first and second fluid holes 4a and 4b of the joined component 100 are separately sprayed from the joined component 100 without being mixed therein. In other words, the first process fluid is sprayed through the first fluid holes 4a while the second process fluid is sprayed through the second fluid holes 4b. This prevents the problem that the process fluids may be mixed in the joined component 100 and react with each other to cause an undesired chemical reaction to occur.

On the contrary, in a fluid passing member in the related art, a structure capable of separately spraying process fluids is not provided. Accordingly, the process fluids are injected in an already mixed state and the mixed process fluids are sprayed through fluid holes. When the process fluids are injected into the fluid passing member in an already mixed state, the process fluids may react in the fluid passing member before being sprayed through the fluid holes, causing an undesired chemical reaction to occur. Accordingly, the joined component 100 may not be properly sprayed onto a wafer or glass, which may result in failing to form a film on the wafer or glass, thus resulting in production of a defective product.

However, the present invention is characterized by providing a structure in which the first and second fluid holes 4a and 4b providing passages through which the first and second process fluids pass, respectively, are provided separately such that the process fluids are separately injected into the joined component 100. This prevents the problem that the process fluids injected into the joined component 100 may react with each other before being sprayed, causing an undesired chemical reaction to occur. Therefore, it is ensured that the joined component 100 sprays different process fluids separately through the respective first and second fluid holes 4a and 4b, thus efficiently forming a thin film in a semiconductor manufacturing process or display manufacturing process.

As shown in FIG. 2B, the joined component 100 includes the first fluid holes 4a passing through the parent members 1 in the weld zones w, and providing passages through which the first process fluid passes. The joined component 100 further includes the second fluid holes 4b being in communication with the first hollow channels 201, and providing passages through which the second process fluid passes. The second fluid holes 4b being in communication with the first hollow channels are surrounded by the weld zones w formed by friction stir welding, and the first fluid holes 4a are formed in the weld zones w. By this configuration, mutual physical and chemical action between the first and second fluid holes 4a and 4b is prevented.

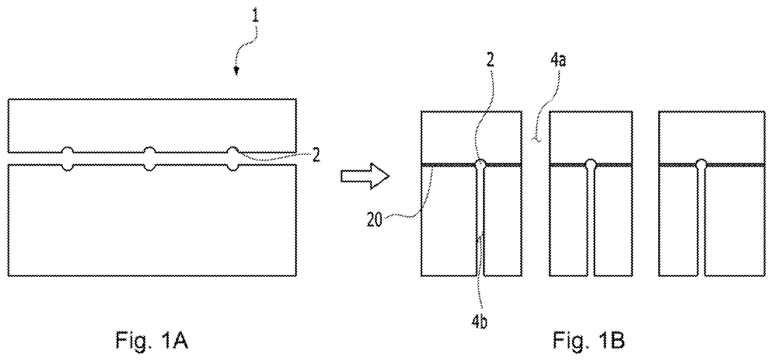

When the parent members 1 are joined by welding or brazing as shown in FIGS. 1A and 1B, a weld joint or braze joint 20 (hereinafter referred to as “weld joint or braze joint 20 of the related art”) is formed at a contact junction between the first and second parent members 1a and 1b. However, the weld joint or braze joint 20 of the related art may corrode when exposed to the process fluids introduced into the first and second fluid holes 4a and 4b. This corrosion may cause particles to be generated inside the first and second fluid holes 4a and 4b, and these particles may be entrained in the first and second process fluids passing through the fluid holes and sprayed together with the process fluids, thus resulting in production of a defective product.

However, in the joined component 100 according to the present invention, due to the fact that the first fluid holes 4a are formed in the weld zones w formed by friction stir welding, no interface between the parent members 1 exists at the inner surfaces of the first fluid holes 4a. The weld zones w are regions formed by friction stir welding in which frictional heat is generated by friction between the pin 10b and the parent members 1, the parent members 1 around the pin 10b are softened by the frictional heat, and the parent members 1 are forcibly mixed together by plastic flow of the parent members 1 occurring on joined surfaces by a stirring action of the pin 10b. Therefore, interfaces between the parent members 1 in the weld zones w are removed because the parent members are forcibly mixed. Furthermore, due to the fact that the second fluid holes 4b are formed in communication with the first hollow channels 201, no weld joint or braze joint 20 of the related art exists at the inner surfaces of the second fluid holes 4b. This prevents the problem that the inner surfaces of the first and second fluid holes 4a and 4b may corrode by the process fluids.

Furthermore, due to the weld zones w in which the first fluid holes 4a are formed, interfaceless regions that result from removal of interfaces may be formed around the first fluid holes 4a and the second fluid holes 4b. This ensures that the first process fluid passing through the first fluid holes 4a and the second process fluid passing through the second fluid holes 4b are not mixed inside the joined component 100. As a result, it is possible to prevent the problem that the process fluids may react inside the joined component 100 and cause an undesired chemical reaction.

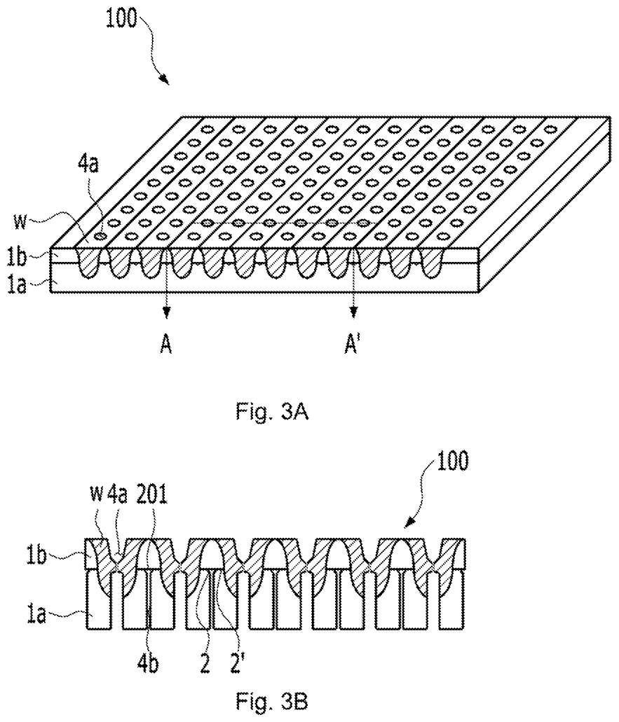

With reference to FIGS. 3A and 3B, a description will be given of the joined component 100 according to the first embodiment of the present invention, formed by friction stir welding the parent members 1 stacked on top of each other. Duplicate descriptions will be omitted, but will be substituted by the above description. Hereinafter, the joined component 100 will be described as having a quadrangular section. However, the sectional shape of the joined component 103 is not limited thereto. The joined component 100 may have a suitable sectional shape according to the configuration.

FIGS. 3A and 38 are views showing the joined component 100 according to the first embodiment of the present invention. FIG. 3A is a perspective view showing the joined component 100 according to the first embodiment of the present invention, and FIG. 3B is a sectional view taken along line A-A′ of FIG. 3A. The joined component 100 according to the first embodiment may be comprised of the first and second parent members 1a and 1b stacked on top of each other.

As shown in FIGS. 3A and 3B, the joined component 100 may be comprised of at least two parent members 1 stacked on top of each other. The parent members 1 may be welded by friction stir welding at the interfaces therebetween. The weld zones w formed by friction stir welding may be formed at the interfaces between the parent members 1. In the weld zones w, each of the first fluid holes 4a may be formed by vertically passing through each of the weld zones w.

The first fluid hole 4a formed in the weld zone w may be smaller in width than the weld zone w. In other words, the first fluid hole 4a may be formed in at least a part of the weld zone w. Due to the first fluid hole 4a formed in at least a part of the weld zone w, the weld zone w may have a shape in which at least a part of the weld zone w surrounds the periphery of the first fluid hole 4a. This ensures that when each of the second fluid holes 4b communicating with each of the first hollow channels provided in non-weld regions where no weld zone w is formed, the weld zone w prevents negative interaction that may occur between the first and second fluid holes 4a and 4b.

The first hollow channels may be defined by first grooves 2 provided in the first parent member 1a. In detail, the first parent member 1a may include first groove regions in which the first grooves 2 are formed and first non-groove regions 2′ in which the first grooves 2 are not formed. In the first groove regions, the second fluid holes 4b may be formed in communication with the first grooves 2. This ensures that the second fluid holes 4b are formed in communication with the first hollow channels 201 inside the joined component 100.

The second parent member 1b may be located on one surface of the first parent member 1a. In this case, the first parent member 1a may be a below-located parent member 1 among the parent members 1 stacked on top of each other. Therefore, the second parent member 1b located on one surface of the first parent member 1a may have a shape located on a top surface of the first parent member 1a. In other words, one surface of the first parent member 1a may be the top surface.

Due to the fact that the joined component 100 of the first embodiment is constituted by the first and second parent members 1a and 1b stacked on top of each other, the joined component 100 may have a shape in which the second parent member 1b is welded to at least a part of the first parent member 1a by friction stir welding on top of the first parent member 1a. In this case, each of the weld zones w is formed by welding the second parent member 1b to at least a part of the first parent member 1a by friction stir welding.

In the weld zone w, each of the first fluid holes 4a may be formed by vertically passing through the first and second parent members 1a and 1b.

Meanwhile, the first hollow channels 201 may be formed in at least parts of at least one of the contact surfaces where no weld zone for welding the first and second parent members 1a and 1b is formed. The first hollow channels 201 may be defined by the first groove regions in which the first grooves 2 of the first parent member 1a are formed. Therefore, in the joined component 100, the first groove regions may be located in at least parts of at least one of the contact surfaces where no weld zone for welding the first and second parent members 1a and 1b is formed. Due to the fact that the first groove regions are located in at least parts of at least one of the contact surfaces where no weld zone for welding the first and second parent members 1a and 1b is formed, the joined component 100 may have a shape in which the first hollow channels 201 are formed in at least parts of at least one of the contact surfaces where no weld zone for welding the first and second parent members 1a and 1b is formed.

In the joined component 100, the second fluid holes 4b may be formed in communication with the first hollow channels 210. The first hollow channels 201 are defined by grooves 2 formed in at least one of the contact surfaces of the parent members 1. This ensures that the second fluid holes 4b are formed in communication with the grooves 2 formed in at least one of the contact surfaces of the parent members 1.

Unlike the first fluid holes 4a formed by vertically passing through the parent members 1, the second fluid holes 4b are formed in communication with the first hollow channels 201 formed in at least one of the contact surfaces of the parent members 1. This configuration ensures that the first fluid holes 4a and the second fluid holes 4b are formed as separate holes in the joined component 100. As a result, it is possible to respectively supply different process fluids separately to the first fluid holes 4a and the second fluid holes 4b.

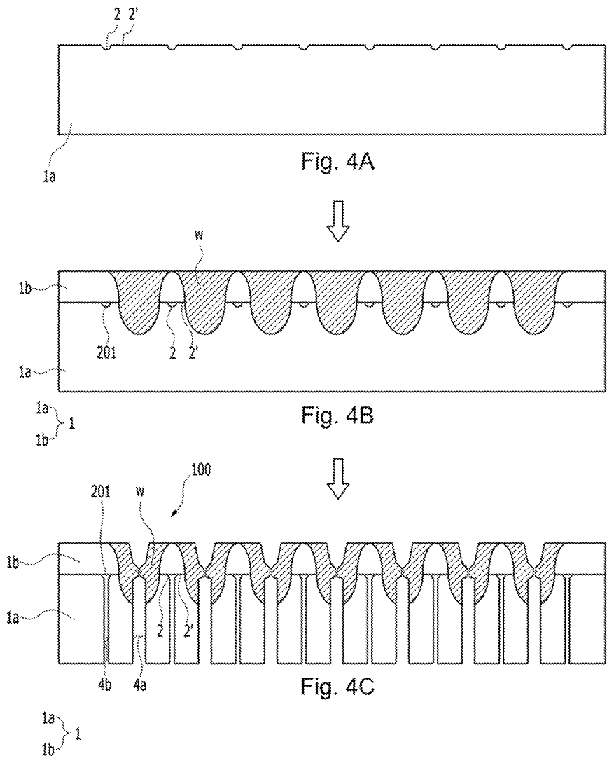

FIGS. 4A to 4C are views schematically showing a manufacturing process of the joined component 100 according to the first embodiment of the present invention.

First, as shown in FIG. 4A, the first parent member 1a may include the first groove regions in which the first grooves 2 are formed and the first non-groove regions 2′ in which the first grooves 2 are not formed. In this case, in the manufacturing process of the first embodiment of the present invention, the first parent member 1a including the first grooves 2 is placed first. However, the order in which the parent members 1 are placed is not limited thereto.

Then, as shown in FIG. 4B, the second parent member 1b may be placed on one surface of the first parent member 1a. The parent members 1 may then be welded by friction stir welding. In this case, portions welded by friction stir welding may be the first non-groove regions 2′ and first regions of the second parent member 1b that face the first non-groove regions 2′. The weld zones w are formed thereby.

Then, as shown in FIG. 4C, the first fluid holes 4a vertically passing through the weld zones w may be formed. In this case, each of the first fluid holes 4a may be formed in at least a part of each of the weld zones w in a shape that vertically passes through the parent members 1.

As shown in FIG. 4C, in the step of forming the first fluid holes 4a, the second fluid holes 4b being in communication with the first hollow channels may be formed. In the present invention, the second fluid holes 4b are formed in the same step as the first fluid holes 4a. However, as shown in FIG. 48, the second fluid holes 4b may be formed after the parent members 1 are welded by friction stir welding as shown in FIG. 4B. In other words, the second fluid holes 4b may be formed before the formation of the first fluid holes 4a. Alternatively, the second fluid holes 4b may be formed after forming the first fluid holes 4a.

As described above, the joined component 100 includes the first fluid holes 4a providing passages through which the first process fluid passes, and the second fluid holes 4b being in communication with the first hollow channels 201 and providing passages through which the second process fluid passes. This makes it possible to supply different process fluids separately to respective fluid holes in a semiconductor manufacturing process or a display manufacturing process such as a CVD process using plasma. The joined component 100 manufactured as described above has in a structure in which different process fluids are introduced separately into respective fluid holes. This prevents a chemical reaction problem of mixed process fluids which may be generated inside the joined component 100 due to the mixed process fluids injected into the joined component 100.

In addition, in the joined component 100, the first fluid holes 4a are formed by passing through the weld zones w, and the second fluid holes 4b are formed in communication with the first hollow channels 201 formed in the contact surfaces of the parent members 1. Due to the fact that the weld zones w are regions in which interfaces of the parent members 1 are removed by friction stir welding, no interface exists at the inner surfaces of the first fluid holes 4a formed by passing through the weld zones w. In addition, the first hollow channels 201 are defined by the grooves 2 formed in at least parts of at least one of the contact surfaces of the parent members 1 where no weld zone is formed. Therefore, the first hollow channels 201 are free of the weld joint or braze joint 20 of the related art. Due to the fact that the second fluid holes 4b are formed in communication with the first hollow channels 201, no weld joint or braze joint 20 of the related art exists at the inner surfaces of the second fluid holes 4b.

The joined component 100 including the first and second fluid holes 4a and 4b as described above provides an advantage of preventing the problem that the weld joint or braze joint 20 of the related art existing at the inner surfaces of the fluid holes may be exposed to the process fluids and corroded. This makes it possible to prevent the problem that particles generated in the fluid holes due to corrosion may be sprayed together with the process fluids, thus resulting in production of a defective product.

FIGS. 5A to 5C are views schematically showing a manufacturing process of a modification of the joined component 100 according to the first embodiment. A joined component 100 of the modification differs from that of the first embodiment in that the number of parent members 1 is different and thus first and second hollow channels 201 and 202 are provided inside the joined component 100. Similarly to the joined component 100 of the first embodiment, in the joined component 100 of the modification, a second parent member 1b is stacked on a top surface, that is, one surface, of a first parent member 1a, and a third parent member 1c is placed on a bottom surface of the first parent member 1a. In this case, the shape of the parent members 1 and the form in which the parent members 1 are stacked are described as an example only, and are not limited thereto.

The joined component 100 of the modification includes the first parent member 1a, the second parent member 1b, and the third parent member 1c.

The first parent member 1a may include a first groove region in which the first groove 2 is formed, and a first non-groove region 2′ in which the first groove 2 is not formed.

The second parent member 1b may be located on one surface of the first parent member 1a. The second parent member 1b may include second groove regions in which second grooves 3 are formed and second non-groove regions 3′ in which the second grooves 3 are not formed. The joined component 100 may include second hollow channels 202 defined therein by the second grooves 3 of the second parent member 1b. Each of the second hollow channels 202 may include a temperature control means (not shown) provided therein. This imparts a temperature control function to the joined component 100 such that the joined component controls the temperature itself through the temperature control means. The provision of the temperature control mean ensures that the joined component 100 has the effect of securing temperature uniformity and of minimizing occurrence of a problem of malfunction due to product deformation.

The temperature control means may be a fluid.

When the temperature control means is a fluid, a cooling fluid or a heating fluid may be provided. When the temperature control means is a cooling fluid, the joined component 100 may function as a cooling block. On the other hand, when the temperature control means is a heating fluid, the joined component 100 may function as a heating block.

On the other hand, when the temperature control means is a hot wire, the joined component 100 may function as a heater.

The third parent member 1c may be placed on one surface of the second parent member 1b.

In the parent members 1 configured as described above, the first non-groove regions 2′, the second non-groove regions 3′, and regions of the third parent member 1c may be welded by friction stir welding to form weld zones w.

The manufacturing process of the modification is described in detail with reference to FIGS. 5A to 5C.

First, as shown in FIG. 5A, to manufacture the joined component 100 of the modification, first, second, and third parent members 1a, 1b, and 1c may be provided. In this case, the first, second, and third parent members 1a, 1b, and 1c are stacked in the order of the second parent member 1b, the first parent member 1a, and the third parent member 1c from top to bottom on the drawings.

Then, as shown in FIG. 5B, the first non-groove regions 2′ of the first parent member 1a, the second non-groove regions 3′ of the second parent member 1b, and regions of the third parent member 1c are welded by friction stir welding to form the weld zones w. In this case, in FIG. 5B, the weld zones w are formed by simultaneously welding the first, second, and third parent members 1a, 1b, and 1c by friction stir welding. However, when three parent members 1a, 1b, and 1c are stacked on top of each other and welded by friction stir welding, two parent members 1a and 1b may be first welded by friction stir welding, and then the remaining one parent member 1c may be welded by friction stir welding to the welded parent members 1a and 1b. For example, the first and second parent members 1a and 1b may be welded by friction stir welding, and then the remaining third parent member 1c may be placed on the bottom surface of the first parent member 1a to be welded by friction stir welding. Alternatively, the third and first parent member 1c and 1a may be first welded by friction stir welding, and then the remaining second parent member 1b may be stacked on the top surface of the first parent member 1a to be welded by friction stir welding.

As shown in FIG. 5B, after the parent members 1 are welded by friction stir welding, a temperature control means may be provided in each of the second hollow channels 202. The temperature control means may be provided after forming the first fluid holes 4a in FIG. 5C which will be described later.

Then, as illustrated in FIG. 5C, the first fluid holes 4a may be formed by vertically passing through the weld zones w. Furthermore, the second fluid holes 4b may be formed in communication with the first hollow channels 201 defined by the first grooves 2. The second fluid holes 4b may be formed by passing through upper and lower portions of the third parent member 1c, in communication with the first hollow channels 201. In this case, the order of forming the first fluid holes 4a or the second fluid holes 4b is not limited. In detail, the second fluid holes 4b may be formed before the formation of the first fluid holes 4a. The second fluid holes 4b may be formed in communicate with the first hollow channels 201 after welding the parent members 1 by friction stir welding in FIG. 5B. Alternatively, the second fluid holes 4b may be formed after forming the first fluid holes 4a in FIG. 5C.

The first hollow channels 201 being in communication with the second fluid holes 4b are formed in at least parts of at least one of the contact surfaces of the parent members 1 where no weld zone is formed. Therefore, gaps may exist at interfaces between the parent members 1. In this case, the weld zones w in which the first fluid holes 4a are formed may prevent adverse interaction that may occur between the process fluids moving along the interfaces between the parent members 1.

Due to the provision of the first and second fluid holes 4a and 4b, and the first and second hollow channels 201 and 202, the joined component 100 of the modification provides the effect of preventing an undesired chemical reaction from occurring due to mixed process fluids injected into the joined component 100 and of securing uniformity of the temperature of a product itself.

In addition, due to the provision of the temperature control means, the joined component 100 of the modification ensures that correction of bending deformation is made more quickly. For example, when welding is entirely performed along interfaces between at least two parent members, the parent members exhibit an integrated behavior due to temperature gradient. On the other hand, as in the joined component 100 according to the present invention, when friction stir welding is performed along at least a part of each of the interfaces between at least two parent members 1 and at least a part remains unwelded, the parent members 1 exhibit a separate behavior in a region except for the weld zones W. In the configuration in which the parent members 1 are partially welded, the cross-sectional area is divided into upper and lower two areas and exhibits a separate behavior in response to application of a bending force. On the contrary, in the configuration in which the parent members 1 are entirely welded, the cross-sectional area exhibits an integrated behavior in response to application of a bending force. Therefore, in the configuration in which the parent members 1 are partially welded as in the joined component 100 according to the present invention, it is ensured that correction of bending deformation by the temperature control means is made more quickly, which is advantageous over the configuration in which at least two parent members 1 are entirely welded.

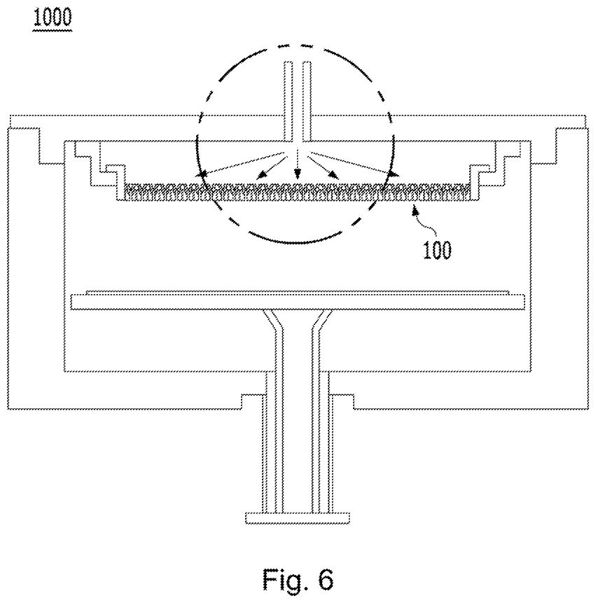

The joined component 100 according to the present invention may be provided in semiconductor manufacturing process equipment or display manufacturing process equipment 1000. FIG. 6 is a view schematically showing semiconductor manufacturing process equipment or display manufacturing process equipment 1000 including the joined component 100 according to the present invention. In FIG. 6, the joined component 100 provided in the semiconductor manufacturing process equipment or display manufacturing process equipment 1000 is the joined component 100 of the first embodiment. However, the joined component 100 is not limited thereto, and the joined component 100 of the modification may be provided.

The joined component 100 provided in the semiconductor manufacturing process equipment or display manufacturing process equipment 1000 is formed by welding at least two parent members 1 by friction stir welding. The weld zones w formed by friction stir welding are formed at the parent members 1, and the first fluid holes 4a providing passages through which the first process fluid passes are formed in the weld zones w. Furthermore, the first hollow channels 201 are formed inside the joined component 100, and the second fluid holes 4b providing passages through which the second process fluid passes are formed in communication with the first hollow channels 201. The joined component 100 respectively supplies different process fluids separately through the first fluid holes 4a and the second fluid holes 4b, which are formed separately.

When the joined component 100 is provided in the semiconductor manufacturing process equipment 1000, the joined component 100 may supply a fluid through the first fluid holes 4a and the second fluid holes 4b to manufacture a component of a semiconductor. The semiconductor manufacturing process equipment 1000 includes etching equipment, cleaning equipment, heat treatment equipment, ion implantation equipment, sputtering equipment, CVD equipment, or the like which will be described below.

The semiconductor manufacturing process equipment 1000 including the joined component 100 may be etching equipment. In this case, the joined component 100 may be a joined component 100 for supplying a process fluid for an etching process to a workpiece. The process fluid may be comprised of the first process fluid passing through the first fluid holes 4a and the second process fluid passing through the second fluid holes 4b.

The joined component 100 may supply the first process fluid through the first fluid holes 4a formed in the weld zones w formed by friction stir welding. Furthermore, the joined component 100 may supply the second process fluid through the second fluid holes 4b formed in communication with the first hollow channels 201.

The etching equipment including the joined component 100 may be used to pattern a portion on a wafer, using the first and second process fluids respectively passing through the first and second fluid holes 4a and 4b of the joined component 100. The etching equipment may be wet etching equipment, dry etching equipment, plasma etching equipment, or reactive ion etching (RIE) equipment.

The joined component 100 provided in the etching equipment may respectively supply the first and second process fluids separately through the first and second fluid holes 4a and 4b. This prevents the problem of the fluid passing member in the related art that when mixed process fluids are injected into the fluid passing member, the mixed process fluids may react therein before being sprayed onto a wafer, causing an undesired chemical reaction to occur.

Furthermore, in the joined component 100, the first fluid hole 4a are formed in the weld zones w formed by friction stir welding, and the weld zones w prevent the process fluids passing through the first and second fluid holes 4a and 4b from moving along interfaces and mixing.

Furthermore, due to the fact that no weld joint or braze joint 20 of the related art exists at the inner surfaces of the first and second fluid holes 4a and 4b, there is less risk of corrosion that may occur due to the weld joint or braze joint 20 of the related art exposed to the process fluids. When the weld joint or braze joint 20 of the related art exists at the inner surfaces of the fluid holes, the weld joint or braze joint 20 of the related art may corrode to cause particles to be generated. These particles may be sprayed together with the process fluids to cause a defective wafer. However, in the joined component 100 according to the present invention, due to the fact that the first fluid holes 4a are formed in the weld zones w formed by friction stir welding and the second fluid holes 4b are formed in communication with the first hollow channels 201 formed in at least one of the contact surfaces of the parent members 1, no interface exists at the inner surfaces of the fluid holes. This makes it possible for the joined component 100 to prevent the problem that corrosion on the inner surfaces of the fluid holes may increase, and to reduce the rate of defective wafers that may occur due to spraying of process fluids in which particles are entrained.

The semiconductor manufacturing process equipment 1000 including the joined component 100 may be cleaning equipment. In this case, the joined component 100 may supply a process fluid for a cleaning process to a workpiece. The process fluid may be comprised of the first process fluid passing through the first fluid holes 4a and the second process fluid passing through the second fluid holes 4b.

The joined component 100 may supply the first process fluid through the first fluid holes 4a formed in the weld zones w formed by friction stir welding. Furthermore, the joined component 100 may supply the second process fluid through the second fluid holes 4b formed in communication with the first hollow channels 201.

The cleaning equipment including the joined component 100 may be used to clean particulate or chemical foreign substances that may cause defects in a manufacturing process, using the first and second process fluids respectively passing through the first and second fluid holes 4a and 4b of the joined component 100. The cleaning equipment may be a cleaner or a wafer scrubber.

The joined component 100 provided in the cleaning equipment may respectively supply the first and second process fluids separately through the first and second fluid holes 4a and 4b. This prevents the problem of the fluid passing member in the related art that when mixed process fluids are injected into the fluid passing member, the mixed process fluids may react therein before being sprayed onto a wafer, causing an undesired chemical reaction to occur.

Furthermore, in the joined component 100, the weld zones w formed by friction stir welding in which the first fluid holes 4a are formed prevent the process fluids passing through the first and second fluid holes 4a and 4b from moving along interfaces and mixing. Therefore, it is possible to prevent the problem that different process fluids may be mixed and react inside the joined component.

Furthermore, in the joined component 100 according to the present invention, no weld joint or braze joint 20 of the related art exists at the inner surfaces of the first and second fluid holes 4a and 4b. Therefore, it is ensured that the risk of corrosion which may occur due to exposure of the inner surfaces of the fluid holes to the process fluids is reduced. When the weld joint or braze joint 20 of the related art exists at the inner surfaces of the fluid holes, corrosion may occur to cause particles to be generated. In this case, these particles may be entrained in the process fluids passing through the fluid holes and sprayed together with the process fluids, causing a defective wafer. However, in the joined component 100 according to the present invention, no weld joint or braze joint 20 of the related art exists at the inner surfaces of the fluid holes. This ensures that the risk of increased corrosion is reduced and particle generation due to corrosion is reduced.

The semiconductor manufacturing process equipment 1000 including the joined component 100 may be heat treatment equipment. In this case, the joined component 100 may supply a process fluid for a heat treatment process to a workpiece. The process fluid may be comprised of the first process fluid passing through the first fluid holes 4a and the second process fluid passing through the second fluid holes 4b.

The joined component 100 may supply the first process fluid through the first fluid holes 4a formed in the weld zones w formed by friction stir welding. Furthermore, the joined component 100 may supply the second process fluid through the second fluid holes 4b formed in communication with the first hollow channels 201. The heat treatment equipment including the joined component 100 may apply heat at a high speed to activate dopants implanted by a method such as ion implantation and may form an oxide film, a nitride film, and the like.

When the joined component 100 provided in the heat treatment equipment, the joined component 100 may respectively supply the first and second process fluids separately through the first and second fluid holes 4a and 4b. This prevents the problem of the fluid passing member in the related art that when mixed process fluids are injected into the fluid passing member, the mixed process fluids react therein before being sprayed onto the wafer, causing an undesired chemical reaction to occur.

Furthermore, due to the fact that the first fluid holes 4a are formed in the weld zones w formed by friction stir welding, the joined component 100 may have a shape in which the peripheries of the first fluid holes 4a are surrounded by the weld zones w. When the second fluid holes 4b are formed adjacent to the first fluid holes 4a, the weld zones w prevent the process fluid passing through the first and second fluid holes 4a and 4b from moving along interfaces and mixing.

Furthermore, due to the fact that no weld joint or braze joint 20 of the related art exists at the inner surfaces of the first and second fluid holes 4a and 4b, there is less risk of corrosion that may occur due to the weld joint or braze joint 20 of the related art exposed to the process fluids. When the weld joint or braze joint 20 of the related art exists at the inner surfaces of the fluid holes, the weld joint or braze joint 20 of the related art may corrode to cause particles to be generated. These particles may be sprayed together with the process fluids to cause a defective wafer. However, in the joined component 100 according to the present invention, due to the fact that the first fluid holes 4a are formed in the weld zones w formed by friction stir welding and the second fluid holes 4b are formed in communication with the first hollow channels 201 formed in at least one of the contact surfaces of the parent members 1, no interface exists at the inner surfaces of the fluid holes. This makes it possible for the joined component 100 to prevent the problem that corrosion on the inner surfaces of the fluid holes may increase, and to reduce the rate of defective wafers that may occur due to spraying of process fluids in which particles are entrained.

The semiconductor manufacturing process equipment 1000 including the joined component 100 may be ion implantation equipment. In this case, the joined component 100 may supply a process fluid for an ion implantation process to a workpiece. The process fluid may be comprised of the first process fluid passing through the first fluid holes 4a and the second process fluid passing through the second fluid holes 4b.

The joined component 100 may supply the first process fluid through the first fluid holes 4a formed in the weld zones w formed by friction stir welding. Furthermore, the joined component 100 may supply the second process fluid through the second fluid holes 4b formed in communication with the first hollow channels 201.

The ion implantation equipment including the joined component 100 may actively pressurize impurity atoms (preferably 3 to 5) to give a certain electrical resistance onto the surface of a wafer 200.

The joined component 100 provided in the implantation equipment may respectively supply the first and second process fluids separately through the first and second fluid holes 4a and 4b. This prevents the problem of the fluid passing member in the related art that when mixed process fluids are injected into the fluid passing member, the mixed process fluids may react therein before being sprayed onto a wafer, causing an undesired chemical reaction to occur.

Furthermore, in the joined component 100, the first fluid holes 4a may be formed in the weld zones w formed by friction stir, and the second fluid holes 4b may be formed adjacent to the first fluid holes 4a. In this case, the weld zones w may serve to prevent the process fluids passing through the first and second fluid holes 4a and 4b from moving along interfaces and mixing.

Furthermore, due to the fact that the first fluid holes 4a are formed in the weld zones w, no interface exists at the inner surfaces of the first fluid holes. Furthermore, due to the fact that the second fluid holes 4b are formed in communication with the first hollow channels 201 formed in at least one of the contact surfaces of the parent members 1, no weld joint or braze joint 20 of the related art exists at the inner surfaces of the second fluid holes. This prevents the problem that the weld joint or braze joint 20 of the related art existing at the inner surfaces of the fluid holes may be exposed to the process fluids and cause corrosion. Corrosion occurring on the inner surfaces of the fluid holes may cause the problem of particle generation. In this case, the particles may be entrained in the process fluids passing through the fluid holes and sprayed together with the process fluids, causing a defective product. However, in the present invention, no weld joint or braze joint 20 of the related art exists at the inner surfaces of the first and second fluid holes 4a and 4b. Therefore, it is ensured that the risk of corrosion on the inner surfaces of the fluid holes is low, and that the problem of particle generation due to corrosion is reduced.

The semiconductor manufacturing process equipment 1000 including the joined component 100 may be sputtering equipment. The joined component 100 may supply a process fluid for a sputtering process to a workpiece. The process fluid may be comprised of the first process fluid passing through the first fluid holes 4a and the second process fluid passing through the second fluid holes 4b.

The joined component 100 may supply the first process fluid through the first fluid holes 4a formed in the weld zones w formed by friction stir welding. Furthermore, the joined component 100 may supply the second process fluid through the second fluid holes 4b formed in communication with the first hollow channels 201.

The sputtering equipment including the joined component 100 is a device for forming a metal film on the wafer 200. The sputtering equipment may form a metal film on the surface of the wafer 200 using a sputter profile.

The joined component 100 provided in the sputtering equipment may respectively supply the first and second process fluids separately through the first and second fluid holes 4a and 4b. This prevents the problem of the fluid passing member in the related art that when mixed process fluids are injected into the fluid passing member, the mixed process fluids may react therein before being sprayed onto a wafer, causing an undesired chemical reaction to occur.

Furthermore, in the joined component 100, the first fluid holes 4a may be formed in the weld zones w formed by friction stir, and the second fluid holes 4b may be formed adjacent to the first fluid holes 4a. In this case, the weld zones w may serve to prevent the process fluids passing through the first and second fluid holes 4a and 4b from moving along interfaces and mixing.

Furthermore, in the joined component 100, no weld joint or braze joint 20 of the related art exists at the inner surfaces of the first and second fluid holes 4a and 4b. Therefore, there is low risk of corrosion that may occur due to the weld joint or braze joint 20 of the related art exposed to the process fluids passing through the fluid holes. When the weld joint or braze joint 20 of the related art exists at the inner surfaces of the fluid holes, the weld joint or braze joint 20 of the related art may corrode to cause particles to be generated. These particles may be sprayed together with the process fluids to cause a defective wafer. However, in the joined component 100 according to the present invention, due to the fact that the first fluid holes 4a are formed in the weld zones w formed by friction stir welding and the second fluid holes 4b are formed in communication with the first hollow channels 201 formed in at least one of the contact surfaces of the parent members 1, no interface exists at inner surfaces of the fluid holes. This makes it possible for the joined component 100 to prevent the problem that corrosion on the inner surfaces of the fluid holes may increase, and to reduce the rate of defective wafers that may occur due to spraying of process fluids in which particles are entrained.

The semiconductor manufacturing process equipment 1000 including the joined component 100 may be CVD equipment. The joined component 100 may supply a process fluid for a CVD process to a workpiece. The process fluid may be comprised of the first process fluid passing through the first fluid holes 4a and the second process fluid passing through the second fluid holes 4b.

The joined component 100 may supply the first process fluid through the first fluid holes 4a formed in the weld zones w formed by friction stir welding. Furthermore, the joined component 100 may supply the second process fluid through the second fluid holes 4b formed in communication with the first hollow channels 201.

The CVD equipment including the joined component 100 may be used to deposit a thin film on the surface of the wafer 200 by chemical reaction occurring in electrons or vapor phases by exciting a reaction process fluid composed of elements with energy, such as a thermal plasma discharge, photo-discharge, or the like. The CVD equipment may be atmospheric pressure CVD equipment, reduced pressure CVD equipment, plasma CVD equipment, photo-initiated CVD equipment, or MO-CVD equipment.

The joined component 100 provided in the CVD equipment may be a showerhead used in a semiconductor manufacturing process.

When the equipment shown in FIG. 6 is CVD equipment of the semiconductor manufacturing process equipment 1000, the joined component 100 may be a showerhead.

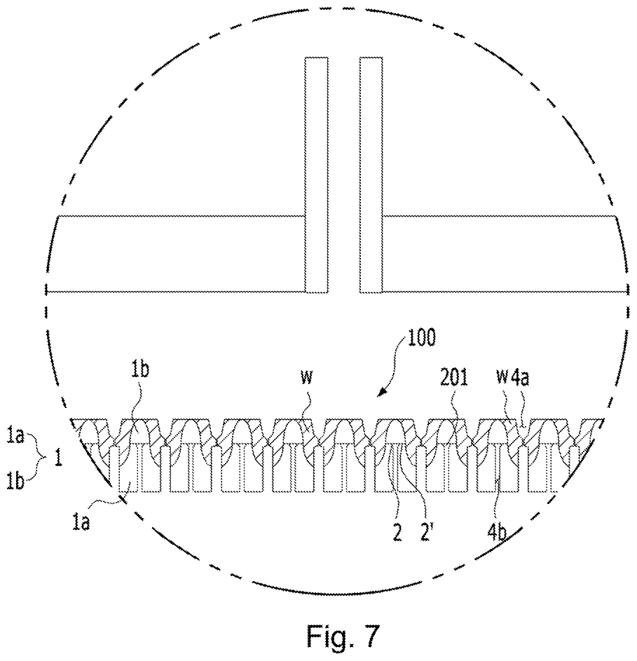

As shown in FIG. 6, the first process fluid may pass through the first fluid holes 4a to be sprayed onto the wafer installed on a susceptor. FIG. 7 is an enlarged view showing a part of the joined component 100 provided in the semiconductor manufacturing process equipment 1000 of FIG. 6. As shown in FIG. 7, the joined component 100 may be comprised of the parent members 1 welded by friction stir welding. In the weld zones w formed by friction stir welding, the first fluid holes 4a are provided by vertically passing through the weld zones w. Furthermore, the second fluid holes 4b are provided in communication with the first hollow channels 201. The first and second process fluids performing a CVD process may be sprayed through the respective fluid holes.

Due to the fact that the first fluid holes 4a through which the first process fluid passes are formed in the weld zones w formed by friction stir welding, no interface exists at the inner surfaces of the first fluid holes. The first fluid holes 4a are surrounded by the weld zones w and the weld zones w are regions formed by friction stir welding, and thus interfaceless regions are formed. This may provide a structure in which the weld zones w exist between the first fluid holes 4a and the first hollow channels 201 and the interfaceless regions exist thereby. Due to the fact that the second fluid holes 4b are formed in communication with the first hollow channels 201, there may be provided a structure in which the weld zones w exist between the first fluid holes 4a and the second fluid holes 4b and the interfaceless regions exist thereby.

The interfaceless regions existing between the first and second fluid holes 4a and 4b ensure that the joined component 100 prevent adverse interaction that may occur between the first and second fluid holes. In detail, due to the fact that the first fluid holes 4a of the joined component 100 are formed in the weld zones w formed by friction stir welding, the risk of corrosion is low and the rate of particle generation due to corrosion is low. Furthermore, the second fluid holes 4b are formed in communication with the first hollow channels 201 formed in at least one of the contact surfaces of the parent members 1. Due to the fact that the first hollow channels 201 are formed in regions of the contact surfaces of the parent members 1 where no weld zone for welding the parent members 1 is formed, no weld joint or braze joint 20 of the related art exists at the inner surfaces of the second fluid holes 4b formed in communication with the first hollow channels 201. In the case of welding or brazing shown in FIGS. 1A and 1B, the weld joint or braze joint 20 of the related art, which is formed by welding or brazing a metal filler material in a molten state at the interfaces of the parent members 1, exists at the inner surfaces of the first and second fluid holes 4a and 4b, and thus the risk of corrosion may be high. In this case, there may arise a problem in that particles generated due to corrosion on the inner surfaces of the first and second fluid holes 4a and 4b may move along interfaces. In addition, in the case of welding or brazing shown in FIGS. 1A and 1B, interfaces exist at the inner surfaces of the first and second fluid holes 4a and 4b, and also exist between the first and second fluid holes 4a and 4b. Therefore, particles generated due to corrosion on the inner surfaces of the first and second fluid holes 4a and 4b and different process fluids nay move along interfaces to cause adverse interaction. However, in the joined component 100 according to the present invention, the first and second fluid holes 4a and 4b do not interact due to the weld zones w between the first and second fluid holes 4a and 4b. Therefore, it is possible to prevent the problem that the process fluids passing through the first and second fluid holes 4a and 4b may be mixed and react to cause an undesired chemical reaction.

The joined component 100 may be provided in display manufacturing process equipment 1000. In this case, the joined component 100 may supply a fluid through the first fluid holes 4a and the second fluid holes 4b to manufacture a component of a display. Unlike the semiconductor manufacturing process equipment 1000, the joined component 100 of the display manufacturing process equipment 1000 may spray the first and second process fluids onto a glass substrate. In this case, the glass substrate may be a flat display such as a liquid crystal display (LCD), a plasma display panel (PDP), or organic light emitting diodes (OLED).

The display manufacturing process equipment 1000 includes etching equipment, cleaning equipment, heat treatment equipment, ion implantation equipment, sputtering equipment, CVD) equipment, or the like. This equipment may perform the same functions as etching equipment, cleaning equipment, heat treatment equipment, ion implantation equipment, sputtering equipment, and CVD equipment of the semiconductor manufacturing process equipment 1000 described above. Therefore, duplicate descriptions will be omitted, but will be substituted by the above description. However, the display manufacturing process equipment 1000 and the semiconductor manufacturing process equipment 1000 differ in that objects onto which the first and second process fluids are sprayed are different (for example, the wafer of the semiconductor manufacturing process equipment 1000 and the glass substrate of the display manufacturing process equipment 1000).

The display manufacturing process equipment 1000 includes the joined component 100 according to the present invention provided in the semiconductor manufacturing process equipment 1000, and thus the effects thereof may be the same as those mentioned in the semiconductor manufacturing process equipment 1000. The joined component 100 provided in the display manufacturing process equipment 1000 may be a diffuser.

As the joined component 100 provided in the display manufacturing process equipment 1000, the joined component 100 of the first embodiment and the joined component 100 according to the modification of the first embodiment may be used. Also, a joined component 100′ of a second embodiment and a joined component 100′ of modifications of the second embodiment may be used, which will be described later.

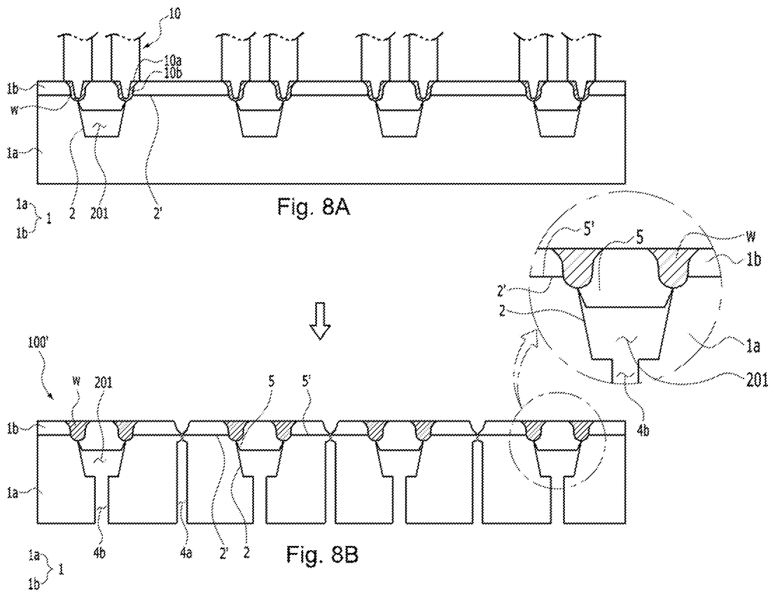

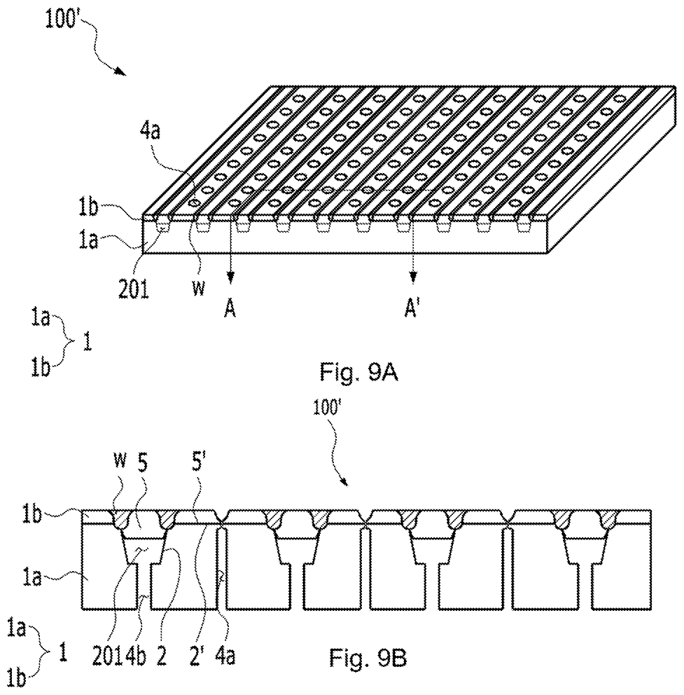

Hereinafter, a joined component 100′ according to a second embodiment of the present invention will be described with reference to FIGS. 8A to 9B. The joined component 100′ of the second embodiment differs from the first embodiment in that the shape of weld zones w formed by friction stir welding, the shape of parent members 1, and the shape of a groove 2 are different, and in that first fluid holes 4a formed in the joined component 100′ do not pass through the weld zones w. Description of the same configuration except for these will be omitted, but will be substituted by the above description.

FIGS. 8A and 8B are views schematically showing an enlarged part of a weld zone of the joined component 100′ according to the second embodiment of the present invention, welded by friction stir welding which is a technical feature of the present invention.

As shown in FIGS. 8A and 8B, the joined component 100′ includes a first parent member 1a, a second parent member 1b located on top of the first parent member 1a, a first fluid hole 4a providing a passage through which a first process fluid passes, and a second fluid hole 4b formed in communication with a first hollow channel 201 and providing a passage through which a second process fluid passes.

As shown in FIG. 8A, the first parent member 1a and the second parent member 1b may be welded by friction stir welding. Friction stir welding may be performed along a contact junction formed on at least a part of each interface between the parent members 1 to form a weld zone w, while at least a part, other than the contact junction where the weld zone w is formed, may remain unwelded.

A groove 2 may be formed in at least one of opposed contact surfaces of the parent members 1. In the joined component 100′ of the second embodiment, as an example, a first groove 2 is formed in the first parent member 1a. For convenience, the same reference numerals are given to the groove 2 and the first groove 2. The first groove 2 defines the first hollow channel 201 inside the joined component 100′. The first parent member 1a may include a first groove region in which the first groove 2 is formed, and a first non-groove region 2′ in which the first groove 2 is not formed. In this case, the first groove region of the first parent member 1a and a first region of the second parent member 1b are not welded together. On the other hand, friction stir welding may be performed along a contact junction formed on at least a part of an interface between the non-groove region 2′ of the first parent member 1a and a second region of the second parent member 1b. A weld zone w may be formed thereby.

Meanwhile, the first fluid hole 4a may be formed at a position where the weld zone w is not formed in the non-groove region 2′ of the first parent member 1a and the second region of the second parent member 1b, which are in an opposed relationship, by vertically passing through the parent members 1. The first fluid hole 4a provides a passage through which the first process fluid passes. It is preferable that the first fluid hole 4a is formed at a position where the weld zone w is not formed in the non-groove region 2′ of the first parent member 1a and the second region of the second parent member 1b, which are in an opposed relationship, and the weld zone W is formed between the first hollow channel 201 and the first fluid hole 4a. This ensures that when the second fluid hole 4b formed in communication with the first hollow channel 201 and providing a passage through which the second process fluid passes is formed, the weld zone w formed to remove at least a part of a horizontal interface between the first and second fluid holes 4a and 4b prevents the problem that the respective process fluids the may move along the interface and react to cause an undesired chemical reaction.

As shown in FIGS. 8A and 8B, the parent members 1 may have shapes capable of fitting together and may be first fitted together before being welded by friction stir welding. The parent members 1 having shapes capable of fitting together may be configured such that a recessed portion such as the groove 2 is formed in the contact surface of at least one of the parent members 1, and a protrusion may be formed on the contact surface of a remaining one of the parent members 1. In the present invention, the first groove 2 is formed in the contact surface of the first parent member 1a and a first protrusion 5 is formed on the contact surface of the second parent member 1b such that the first and second parent members 1a and 1b are fitted together through engagement of the groove and the protrusion. However, the shape of the parent members 1 is not limited thereto. In other words, the parent members 1 may be provided in various shapes as in the first embodiment, other than the shapes capable of fitting together. In addition, in the present invention, the first groove 2 and the first protrusion 5 have a tapered shape. However, this is only an example, and the shape of the groove 2 including the first groove 2 and the protrusion including the first protrusion 5 is not limited thereto. Hereinafter, the parent members 1 will be described as having shapes capable of fitting together to form the joined component 100′.

In the contact surface of the first parent member 1a, the first groove region in which the first groove 2 is formed, and the first non-groove region 2′ in which the first groove 2 is not formed may be provided. Meanwhile, in the contact surface of the second parent member 1b, a protrusion region in which the first protrusion 5 is formed, and a first non-protrusion region 5′ in which the first protrusion 5 is not formed may be provided. In this case, the groove region of the first parent member 1a and the first protrusion region of the second parent member 1b may be opposed to each other, while the first non-groove region of the first parent member 1a and the first non-protrusion region of the second parent member 1b may opposed to each other.

The first groove 2 formed in the contact surface of the first parent member 1a may be larger in depth than the first protrusion 5 such that a lower surface of the first protrusion 5 and a lower surface of the first groove 2 do not come into contact with each other when the first protrusion 5 of the second parent member 1b is fitted into the first groove 2. Due to this configuration, when the second parent member 1b is fitted to the first parent member 1a, the first hollow channel 201 is defined between the first groove 2 of the first parent member 1a and the first protrusion 5 of the second parent member 1b. The second fluid hole 4b providing a passages through which the second process fluid passes is formed in communication with the first hollow channel 201. As shown in FIG. 8B, the second fluid hole 4b is formed in communication with the first hollow channel 201 by passing through a lower portion of the first parent member 1a. As a result, it is ensured that the joined component 100′ respectively supplies different process fluids separately through the first fluid hole 4a and the second fluid hole 4b.

When the parent members 1 are fitted together, a contact junction may be formed. Friction stir welding may be performed along the contact junction to form a weld zone w. As shown in FIG. 8A, the second parent member 1b may be fitted to the first parent member 1a. In this case, the first protrusion 5 of the second parent member 1b may be fitted into the first groove 2 of the first parent member 1a. The fitting may be performed in such a manner that left and right contact surfaces of the first protrusion 5 of the second parent member 1b in a width direction are brought into contact with left and right contact surfaces of the first groove 2 of the first parent member 1a in a width direction, respectively, with the lower surface of the first protrusion 5 of the second parent member 1b not coming into contact with the lower surface of the first groove 2 of the first parent member 1a. As a result, a contact junction is formed on at least a part of at a horizontal interface between the first groove 2 and the first protrusion 5. In the second embodiment, described as an example that the parent members 1 have shapes capable of fitting together and are welded by friction stir welding. Therefore, a contact junction described below may mean an interface between the first groove 2 and the first protrusion 5. In addition, due to the fact that friction stir welding is performed along the contact junction to form a weld zone w, at a least a part of each horizontal interface between the parent members 1 may be included in the range of the weld zone w.

When the second parent member 1b is fitted to the first parent member 1a, the left and right contact surfaces of the first protrusion 5 of the second parent member 1b in the width direction are brought into contact with the left and right contact surfaces of the first groove 2 of the first parent member 1a in the width direction, respectively, and contact junctions are formed thereby. Friction stir welding may be performed along the contact junctions to form weld zones w.

In detail, in FIG. 8A, when the left contact surface (on the drawings) of the first groove 2 of the first parent member 1a in the width direction and the left contact surface (on the drawings) of the first protrusion 5 of the second parent member 1b in the width direction are brought into contact with each other, a left contact junction may be formed on at least a part of a left interface between the first groove 2 and the first protrusion 5. Friction stir welding may be performed along the left contact junction to form a weld zone W. Furthermore, in FIG. BA, when the right contact surface (on the drawings) of the first groove 2 of the first parent member 1a in the width direction and the right contact surface (on the drawings) of the first protrusion 5 of the second parent member 1b in the width direction are brought into contact with each other, a right contact junction may be formed on at least a part of a right interface between the first groove 2 and the first protrusion 5. Friction stir welding may be performed along the right contact junction to form a weld zone w.

As described above, friction stir welding is performed along the left and right contact junctions between the first groove and the first protrusion of the parent members 1 fitted together to form the respective weld zones w. Therefore, the joined component 100′ of the second embodiment may have a shape in which multiple weld zones w are formed on at least parts thereof.

In the joined component 100′ of the second embodiment, described as an example that the weld zones w are formed on the respective left and right contact junctions. However, the weld zones w may be formed as one weld zone w having a range within which the left contact junction and the right contact junction are included. Herein, the one weld zone W may be larger in width than the first groove 2 of the first parent member 1a and than the first protrusion 5 of the second parent member 1b, and may be located a position below a horizontal interface between the first hollow channel 201 and the first fluid hole 4a, with a depth not exceeding the height of the first protrusion 5 of the second parent member 1b.

Due to the formation of the weld zones W on the contact junctions between the parent members 1, the first hollow channel 201 of the joined component 100′ may have a shape that passes through an interior of the joined component 100′. Such a shape of the first hollow channel 201 may be formed by each of the weld zones w removing a part of each interface between the parent members 1, the part being adjacent to the first hollow channel 201. This ensures that the second process fluid passing through the second fluid hole 4b formed in communication with the first hollow channel 201 is prevented from moving to the first fluid hole 4a.

As shown in FIG. 8B, the first fluid hole 4a providing a passage through which the first process fluid passes may be formed in at least a part of the first non-groove region 2′ of the first parent member 1a and the first non-protrusion region 5′ of the second parent member 1b, which are in an opposed relationship, by vertically passing through the parent members 1.

In detail, multiple first grooves 2 may be arranged in the contact surface of the first parent member 1a in a spaced apart relationship, such that first groove regions and first non-groove regions 2′ may be alternately arranged. Furthermore, multiple first protrusions 5 may be formed in the contact surface of the second parent member 1b in a spaced apart relationship, such that first protrusion regions and first non-protrusion regions 5′ may be alternately arranged. In this case, the first groove regions of the first parent member 1a and the first protrusion regions of the second parent member 1b may be opposed to each other, while the first non-groove regions 2′ of the first parent member 1a and the first non-protrusion regions 5′ of the second parent member 1b may be opposed to each other. When the first and second parent members 1a and 1b having the above configurations are first fitted together, contact junctions are formed. Friction stir welding is performed along the contact junctions to form multiple weld zones w.

The first fluid hole 4a is formed between adjacent weld zones w located with the first non-groove region and the first non-protrusion region interposed therebetween. The first fluid hole 4a vertically passes through the parent members 1 and provides a passage through which the first process fluid passes. The first fluid hole 4a may be provided as multiple first fluid holes 4a that are arranged in a spaced apart relationship at an interval of equal to or greater than 3 mm to equal to or less than 15 mm. The first fluid holes 4a are formed to appropriately maintain the arrangement interval at an interval of equal to or greater than 3 mm to equal to or less than 15 mm. This ensures that provision of the second fluid hole 4b is facilitated, and that the problem that spraying efficiency of the first process fluid compared to the supply amount thereof is reduced is prevented.

As shown in FIG. 8B, the multiple first fluid holes 4a vertically passing through the parent members 1 may be provided in the joined component 100′, and the first hollow channel 201 may be provided between each of the first fluid holes 4a. In the above joined component 100′, each of the weld zones w formed by friction stir welding is formed to remove at a least a part of a horizontal interface between each of the first hollow channels 201 and each of the first fluid holes 4a. In each of the first hollow channels 201, the second fluid hole 4b may be formed in communication therewith. Therefore, each of the weld zones w formed by friction stir welding may remove at a least a part of a horizontal interface between each of the first fluid holes 4a and each of the second fluid holes 4b. This prevents the problem that the first process fluid passing through the first fluid hole 4a and the second process fluid passing through the second fluid hole 4b move along the horizontal interface and are mixed inside the joined component 100′ to cause an undesired chemical reaction to occur.

In the joined component 100′ according to the present invention, the first fluid holes 4a that vertically pass through the parent members 1 of the joined component 100′ are formed at regions where no weld zone for welding the parent members 1 is formed. Therefore, no weld joint or braze joint 20 of the related art exists. In addition, the weld zones w are formed on the contact junctions of the parent members 1. Therefore, each of the first hollow channels 201 formed in communication with the second fluid hole 4b has a shape that passes through an interior of the joined component 100′. Such a shape of the first hollow channel 201 may be formed by each of the weld zones w removing a part of each interface between the parent members 1, the part being adjacent to the first hollow channel 201. In the second fluid hole 4b formed in communication with each of the first hollow channels 201 having the above shape, no weld joint or braze joint 20 of the related art exists at the inner surface of the second fluid hole.

As described above, due to the fact that no weld joint or braze joint 20 of the related art exists at the inner surfaces of the first and second fluid holes 4a and 4b, there is less risk of corrosion that may occur due to the weld joint or braze joint 20 of the related art exposed to the process fluids passing through the fluid holes.

The second fluid hole 4b may be provided as multiple second fluid holes 4b that are arranged in a spaced apart relationship at an interval of equal to or greater than 3 mm to equal to or less than 15 mm. The second fluid holes 4a are formed to appropriately maintain the arrangement interval at an interval of equal to or greater than 3 mm to equal to or less than 15 rm. This ensures that spraying efficiency of the second process fluid compared to the supply amount thereof is maintained at an appropriate level without being reduced.

FIG. 9A is a perspective view showing the joined component 100′ according to the second embodiment of the present invention, and FIG. 98 is a sectional view taken along line A-A′ of FIG. 9A. As shown in FIGS. 9A and 9B, the joined component 100′ includes the first and second parent members 1a and 1b, the first and second fluid holes 4a and 4b, and the first hollow channels 201.

As shown in FIG. 9A, the weld zones w formed by friction stir welding may be formed along the first hollow channels 201, whereby each of the weld zones w may remove at a least a part of the horizontal interface between each of the first hollow channels 201 and each of the first fluid holes 4a. Due to the fact that the second fluid holes 4b are formed in communication with the first hollow channels 201, each of the weld zones w may remove at a least a part of the horizontal interface between each of the first fluid holes 4a and each of the second fluid holes 4b. This prevents chemical action which may occur between the first fluid holes 4a and the second fluid holes 4b.

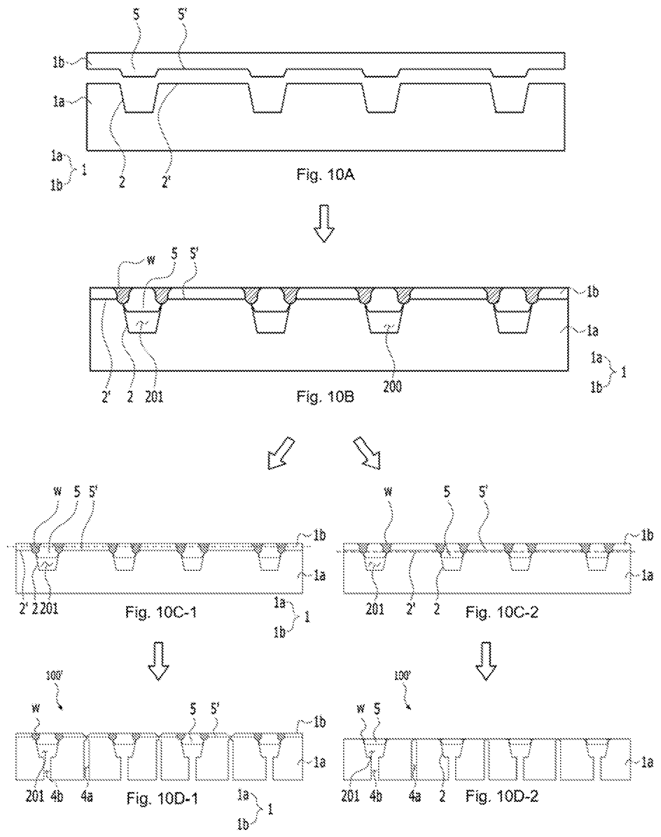

FIGS. 10A to 10D-2 are views schematically showing a manufacturing process of the joined component 100′ according to the second embodiment of the present invention.

First, as shown in FIG. 10A, the first parent member 1a is placed at a lower position on the drawings, and the second parent member 1b is placed on a top surface of the first parent member 1a. The first parent member 1a includes first groove regions and first non-groove regions 2′, and the second parent member 1b includes first protrusion regions and first non-protrusion regions 5′. In this case, the first groove regions of the first parent member 1a and the first protrusion regions of the second parent member 1b are opposed to each other, while the first non-groove regions 2′ of the first parent member 1a and the first non-protrusion regions 5′ of the second parent member 1b are opposed to each other.

Then, as shown in FIG. 10B, the second parent member 1b is fitted to the first parent member 1a, and then friction stir welding is performed along the contact junctions between the parent members fitted together to form the weld zones w. In this case, the first groove regions of the first parent member 1a may be larger in depth than the first protrusion regions of the second parent member 1b such that the first hollow channels 201 are defined inside the joined component 100′.

Then, a process of planarizing the weld zones w formed by friction stir welding may be performed. At least a part of each of the weld zones w may be planarized.

As shown in FIG. 10C-1, planarizing may be performed at a position above horizontal interfaces between the parent members 1, the position being indicated by a dotted line. Then, the first fluid holes 4a may be formed by vertically passing through the patent members 1, and the second fluid holes 4b may be formed in communication with the first hollow channels 201. In this case, the second fluid holes 4b may be formed by passing through lower portions of the first parent member 1a. As a result, a joined component 100′ having a shape as shown in FIG. 10D-1 may be obtained.

On the other hand, the second fluid holes 4b may be formed in communication with the first hollow channels 201 before planarizing. Alternatively, as described above, the second fluid holes 4b may be formed after the formation of the first fluid holes 4a. In other words, the second fluid holes 4b may be formed in any step after the formation of the first hollow channels 201.

Alternatively, as shown in FIG. 10C-2, planarizing may be performed at a position below the horizontal interfaces between the parent members 1, the position being indicated by a dotted line, within a range that does not deviate from the positions of the weld zones w, with respect to a downward direction on the drawings. Then, the first fluid holes 4a may be formed by vertically passing through the patent members 1, and the second fluid holes 4b may be formed in communication with the first hollow channels 201. In this case, the second fluid holes 4b may be formed by passing through lower portions of the first parent member 1a. As a result, a joined component 100′ having a shape as shown in FIG. 10D-2 may be obtained.

On the other hand, the second fluid holes 4b may be formed before planarizing. In other words, the second fluid holes 4b may be formed in any step after the formation of the first hollow channels 201.

In FIG. 10D-1, horizontal interfaces exist between the first fluid holes 4a and the second fluid holes 4b. On the contrary, in the structure of FIG. 10D-2, unlike FIG. 10D-1, no horizontal interface exists between the first fluid holes 4a and the second fluid holes 4b. As a result, it is possible to prevent the problem of movement and mixing of process fluids that may occur at horizontal interfaces. In addition, it is possible to prevent the problem of particle introduction that may occur at horizontal interfaces.

The joined component 100′ of the second embodiment as described above has a structure in which separate provision of the first and second fluid holes 4a and 4b is made. This makes it possible to respectively supply different process fluids separately through the first fluid holes 4a and the second fluid holes 4b. This prevents the problem of the fluid passing member in the related art that when mixed process fluids are injected into the fluid passing member, the mixed process fluids may react therein before being sprayed, causing an undesired chemical reaction to occur.

Hereinafter, a joined component 100′ according to a first modification of the second embodiment of the present invention will be described.

The joined component 100 according to the first modification differs from the second embodiment in that the positions where first fluid holes 4a are formed are overlap portions 7 of weld zones w formed by friction stir welding. Other configurations are the same as those of the first embodiment, and thus the duplicate description thereof will not be repeated.

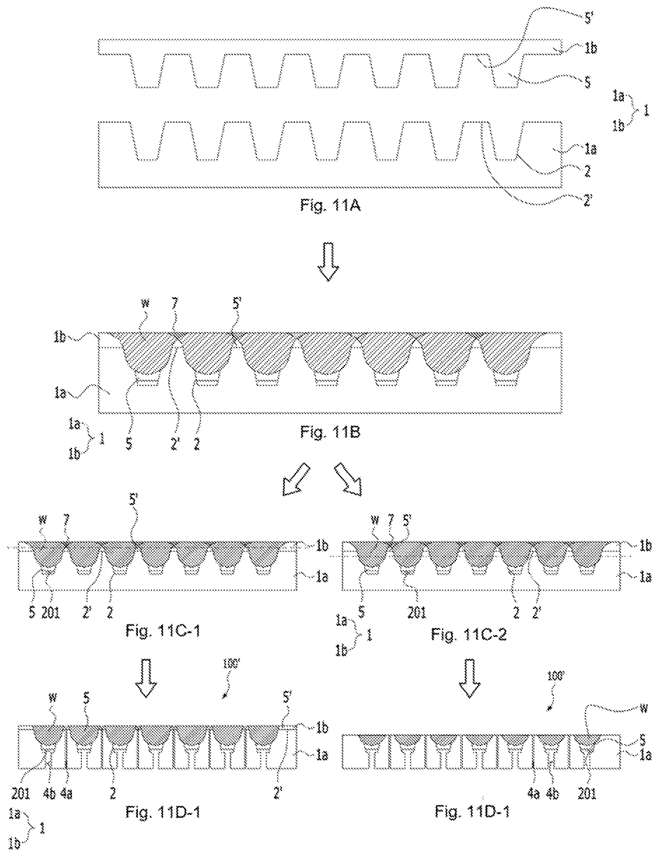

FIGS. 11A to 11D-2 are views schematically showing a manufacturing process of the joined component 100′ according to the first modification of the present invention.

The joined component 100′ according to the first modification is constituted by at least two parent members 1 that are welded by friction stir welding. The joined component 100′ includes: first fluid holes 4a formed by vertically passing through overlap portions 7 where weld zones 4 at least partially overlap each other, and providing passages through which a first process fluid passes; and second fluid holes 4b formed in communication with first hollow channels 201 and providing passages through which a second process fluid passes. In this case, each of the weld zones w formed by friction stir welding may be formed to remove at least a part of a horizontal interface between each of the first fluid holes 4a and each of the second fluid holes 4b.

First, as shown in FIG. 11A, the first parent member 1a is placed at a lower position on the drawings, and the second parent member 1b is placed on a top surface of the first parent member 1a. The first parent member 1a includes first groove regions and first non-groove regions 2′, and the second parent member 1b includes first protrusion regions and first non-protrusion regions 5′. In this case, the first groove regions of the first parent member 1a and first protrusion regions of the second parent member 1b are opposed to each other, while the first non-groove regions 2′ of the first parent member 1a and first non-protrusion regions 5′ of the second parent member 1b are opposed to each other.

Then, the second parent member 1b is fitted to the first parent member 1a, and contact junctions are formed thereby. Then, as shown in FIG. 11B, friction stir welding may be performed along the contact junctions to form weld zones w. Each of the weld zones w is formed to remove at least a part of the horizontal interface between each of the first fluid holes 4a and each of the second fluid holes 4b. In this case, each of the weld zones w may be formed larger in width than each of first grooves 2 of the first parent member 1a and each of first protrusions 5 of the second parent member 1b. In addition, each of the weld zones w may be formed such that the depth thereof reaches a position below a horizontal interface between each of the first hollow channels 201 and each of the first fluid holes 4a, without exceeding the height of the each of the first protrusions 5 of the second parent member 1b. As a result, it is possible to prevent the problem that particles in the weld zones w are introduced into the first hollow channels 201 through non-weld regions, which are at least parts of least one of the contact surfaces of the parent members 1 where no weld zone is formed, and the introduced particles are sprayed together with the second process fluid passing through the second fluid holes 4b.

The weld zones W may be formed with the width and depth as above. The range of each of the weld zones W may include left and right contact junctions, the left contact junction being formed on at least a part of a left interface between a left contact surface (on the drawings) of each of the first grooves 2 of the first parent member 1a and a left contact surface (on the drawings) of each of the first protrusions 5 of the second parent member 1b, the right contact junction being formed on at least a part of a right interface between a right contact surface (on the drawings) of each of the first grooves 2 of the first parent member 1a and a right contact surface (on the drawings) of each of the first protrusions 5 of the second parent member 1b. Due to this, each of the weld zones w may remove at least a part of each of the left and right interfaces between each of the first grooves 2 of the first parent member 1a and each of the first protrusions 5 of the second parent member 1b. In addition, at least a part of the horizontal interface between each of the first hollow channels 201 and each of the first fluid holes 4a may be removed. In FIG. 11B, the second fluid holes 4b to be formed in communication with the first hollow channels 201 are not yet formed. However, as shown in FIG. 11D-1 or FIG. 11D-2, when the second fluid holes 4b are formed in communication with the first hollow channels 201 after the formation of the first hollow channels 201, each of the weld zones w in FIG. 1B may remove at least a part of the horizontal interface between each of the first fluid holes 4a and each of the second fluid holes 4b.

In the joined component 100′, when each of the weld zones w is formed to entirely include the left and right contact junctions and at least a part of the horizontal interface between each of the first fluid holes 4a and each of the second fluid holes 4b, at a least a part of a first weld zone located at the leftmost side on FIG. 11B and at a least a part of a second weld zone adjacent to the first weld zone overlap each other to form an overlap portion 7. Each of the weld zones w includes a nugget zone, a thermo-mechanically affected zone, and a heat affected zone. Therefore, the overlap portion 7 may be formed such that the zones constituting each of the weld zones w at least partially overlap each other.

The overlap portion 7 may be a portion that may be formed when the interval between the first hollow channels 201 formed inside the joined component 100′ is relatively small. Alternatively, the overlap portion 7 may be a portion that may be defined by an insertion depth of a shoulder 10a and a pin 10b of a welding tool 10 performing friction stir welding when the interval between the first hollow channels 201 is relatively large.

After friction stir welding is performed along the contact junctions between the parent members 1 to form the weld zones w, a process of planarizing the weld zones w may be performed. At least a part of each of the weld zones w may be planarized.

As shown in FIG. 11C-1, planarizing may be performed at a position above horizontal interfaces between the parent members 1, the position being indicated by a dotted line. In other words, planarizing may be performed above the horizontal interfaces between the parent members 1.

Then, the first fluid holes 4a may be formed by vertically passing through overlap portions 7, and the second fluid holes 4b may be formed in communication with the first hollow channels 201. In this case, the second fluid holes 4b may be formed by passing through lower portions of the first parent member 1a. As a result, a joined component 100′ having a shape as shown in FIG. 11D-1 may be obtained. The second fluid holes 4b may be formed in any step after the formation of the first hollow channels 201.

Each of the weld zones w nay be formed to remove at least a part of the horizontal interface between each of the first fluid holes 4a and each of the second fluid holes 4b being in communication with the first hollow channels 201, by removing at least a part of the horizontal interface between the each of the first hollow channels 201 and each of the first fluid holes 4a. This prevents adverse interaction which may occur between the first fluid holes 4a and the second fluid holes 4b. In detail, the weld zones w may prevent the first process fluid passing through the first fluid holes 4a or the second process fluid passing through the second fluid holes 4b from moving along the horizontal interfaces between the parent members 1. Therefore, it is possible to prevent the problem that the first and second process fluids may be mixed and react in the joined component 100′ before being sprayed, causing an undesired chemical reaction to occur.

Alternatively, as shown in FIG. 11C-2, planarizing may be performed at a position below the horizontal interfaces between the parent members 1, the position being indicated by a dotted line, within a range that does not deviate from the positions of the weld zones w, with respect to a downward direction on the drawings. In other words, planarizing may be performed below the horizontal interfaces between the parent members 1. A planarizing surface along which planarizing is performed may be located between the depth of the weld zones w and the horizontal interfaces.

Then, the first fluid holes 4a may be formed by vertically passing through the patent members 1, and the second fluid holes 4b may be formed in communication with the first hollow channels 201. In this case, the second fluid holes 4b may be formed by passing through lower portions of the first parent member 1a. As a result, a joined component 100′ having a shape as shown in FIG. 11D-2 may be obtained. The joined component 100′ manufactured as described above may respectively supply different process fluids separately through the first and second fluid holes 4a and 4b. In this case, the second fluid holes 4b may be formed in any step after the formation of the first hollow channels 201.

In FIG. 11D-1, horizontal interfaces exist between the first fluid holes 4a and the second fluid holes 4b.

On the contrary, in the structure of FIG. 11D-2, unlike FIG. 11D-l, no horizontal interface exists between the first fluid holes 4a and the second fluid holes 4b. As a result, it is possible to prevent the problem of movement and mixing of process fluids that may occur at horizontal interfaces. In addition, it is possible to prevent the problem of particle introduction that may occur at horizontal interfaces.

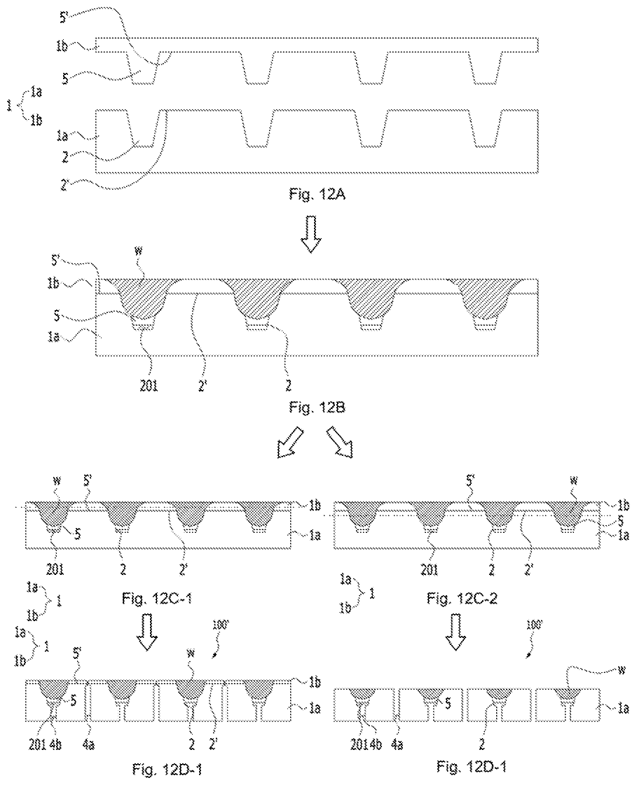

FIGS. 12A to 12D-2 are views schematically showing a manufacturing process of a joined component 100′ according to a second modification of the second embodiment of the present invention. A joined component 100 according to the second modification differs from the second embodiment in that the interval between multiple first hollow channels 201 is relatively larger than that of the second embodiment and thus overlap portions 7 are not formed, but first fluid holes 4a are formed between the first hollow channels 201.

First, as shown in FIG. 12A, a first parent member 1a including first groove regions and first non-groove regions is placed at a lower position on the drawings. A second parent member 1b is placed on a top surface of the first parent member 1a. In this case, the first groove regions of the first parent member 1a and first protrusion regions of the second parent member 1b are opposed to each other, while the first non-groove regions 2′ of the first parent member 1a and first non-protrusion regions 5′ of the second parent member 1b are opposed to each other.

Then, the second parent member 1b is fitted to the first parent member 1a, and contact junctions are formed thereby. Then, as shown in FIG. 12B, friction stir welding may be performed along the contact junctions to form weld zones w. Each of the weld zones w is formed to remove at least a part of a horizontal interface between each of the first hollow channels 201 and each of the first fluid holes 4a. In this case, although not shown in FIG. 12B, but shown in FIG. 12D-1 or FIG. 12D-2, second fluid holes 4b may be formed in the first hollow channels 201 in communication therewith. Therefore, each of the weld zones w formed by friction stir welding may remove at a least a part of a horizontal interface between each of the first fluid holes 4a and each of the second fluid holes 4b.

In this case, each of the weld zones w may be formed larger in width than each of first grooves 2 of the first parent member 1a and each of first protrusions 5 of the second parent member 1b. In addition, each of the weld zones w may be formed such that the depth thereof reaches a position below a horizontal interface between each of the first hollow channels 201 and each of the first fluid holes 4a, without exceeding the height of the each of the first protrusions 5 of the second parent member 1b. As a result, it is possible to prevent the problem that particles in the weld zones w are introduced into the first hollow channels 201 through non-weld regions, which are at least parts of least one of the contact surfaces of the parent members 1 where no weld zone is formed.

Each of the weld zones w may be formed with the width and depth as above. The range of each of the weld zones W may include left and right contact junctions between each of the first grooves and each of the first protrusions. Due to this, each of the weld zones w may remove at least a part of each of left and right interfaces between each of the first grooves 2 of the first parent member 1a and each of the first protrusions 5 of the second parent member 1b. In addition, at least a part of the horizontal interface between each of the first hollow channels 201 and each of the first fluid holes 4a may be removed.

Meanwhile, although not shown in FIG. 12B, the second fluid holes 4b may be formed in communication with the first hollow channels 201 by passing through lower portions of the first parent member 1a. In this case, each of the weld zones w may remove at a least a part of a horizontal interface between each of the first fluid holes 4a and each of the second fluid holes 4b. This prevents the problem that the first process fluid passing through the first fluid holes 4a and the second process fluid passing through the second fluid holes 4b move along horizontal interfaces and are mixed inside the joined component 100′ before being sprayed, causing an undesired chemical reaction to occur.

In FIGS. 12A to 12D-2, the joined component 100′ of the second modification is shown that the interval between the first hollow channels 201 is relatively large and thus overlap portions 7 are not formed, but the first fluid holes 4a are formed between the first hollow channels 201. However, when the depth of the first grooves 2 of the first groove regions of the first parent member 1a is large and the height of the first protrusions 5 of the first protrusion regions of the second parent member 1b is large, a welding tool 10 performing friction stir welding may be deeply inserted and overlap portions 7 may be formed thereby.

After friction stir welding is performed along the contact junctions between the parent members 1 to form the weld zones w, a process of planarizing the weld zones w may be performed. At least a part of each of the weld zones w may be planarized.

As shown in FIG. 12C-1, planarizing may be performed at a position above horizontal interfaces between the parent members 1, the position being indicated by a dotted line. In other words, planarizing may be performed above the horizontal interfaces between the parent members 1.

Then, the first fluid holes 4a may be formed between the first hollow channels 201 by vertically passing through the parent members 1. In addition, the second fluid holes 4b may be formed by passing through the lower portions of the first parent member 1a, in communication with the first hollow channels 201. As a result, a joined component 100′ having a shape as shown in FIG. 12D-1 may be obtained. In this case, the second fluid holes 4b may be formed in any step after the formation of the first hollow channels 201.

Alternatively, as shown in FIG. 12C-2, planarizing may be performed at a position below the horizontal interfaces between the parent members 1, the position being indicated by a dotted line, within a range that does not deviate from the positions of the weld zones w, with respect to a downward direction on the drawings. In other words, planarizing may be performed below the horizontal interfaces between the parent members 1. A planarizing surface along which planarizing is performed may be located between the depth of the weld zones w and the horizontal interfaces.

Then, the first fluid holes 4a may be formed between the first hollow channels 201 by vertically passing through the parent members 1. In addition, the second fluid holes 4b may be formed by passing through the lower portions of the first parent member 1a, in communication with the first hollow channels 201. As a result, a joined component 100′ having a shape as shown in FIG. 12D-2 may be obtained. In this case, the second fluid holes 4b may be formed in any step after the formation of the first hollow channels 201.

In FIG. 12D-1, horizontal interfaces exist between the first fluid holes 4a and the second fluid holes 4b.

On the contrary, in the structure of FIG. 12D-2, unlike FIG. 12D-1, no horizontal interface exists between the first fluid holes 4a and the second fluid holes 4b. As a result, it is possible to prevent the problem of movement and mixing of process fluids that may occur at horizontal interfaces. In addition, it is possible to prevent the problem of particle introduction that may occur at horizontal interfaces.

Each of the weld zones w is formed to remove at least a part of a horizontal interface between each of the first fluid holes 4a and each of the second fluid holes 4b. This prevents adverse interaction which may occur when the process fluids passing through the first and second fluid holes 4a and 4b move along the horizontal interfaces and react undesirably.

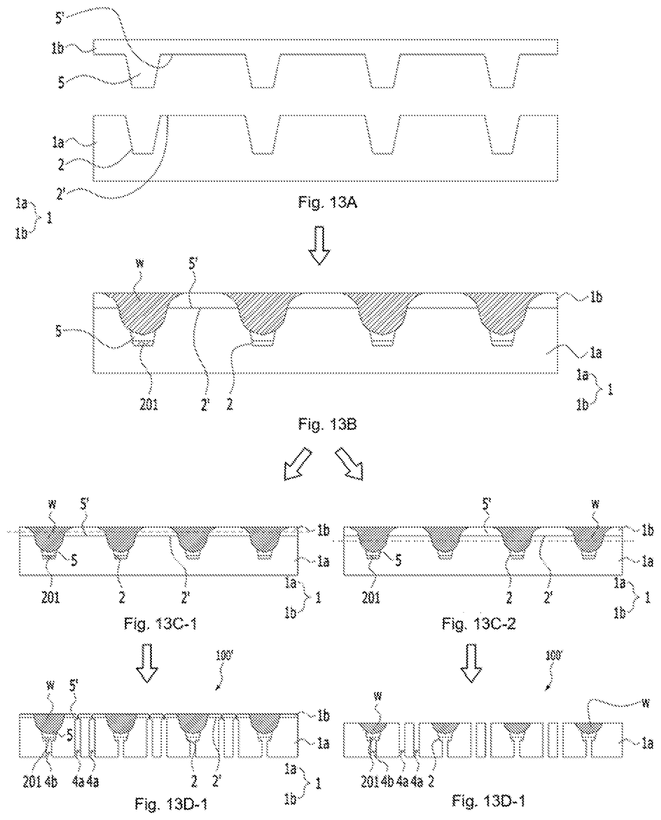

FIGS. 13A to 13D-2 are views schematically showing a manufacturing process of a joined component 100′ according to a third modification of the second embodiment of the present invention. The joined component 100′ of the third modification differs from the second embodiment in that at least two first fluid holes 4a are formed between each of multiple first hollow channels 201, without forming overlap portions 7.

The joined component 100′ of the third modification may include the multiple first hollow channels 201 formed therein. A first fluid hole 4a providing a passage through which a first process fluid passes may be formed between each of the first hollow channels 201. A second fluid hole 4b may be formed in communication with each of the first hollow channels 201 by passing through a lower portion of the parent member 1a.

First, as shown in FIG. 13A, a first parent member 1a including first groove regions and first non-groove regions is placed at a lower position on the drawings. A second parent member 1b including first protrusion regions and first non-protrusion regions 5′ is placed on a top surface of the first parent member 1a. In this case, the first groove regions of the first parent member 1a and the first protrusion regions of the second parent member 1b are opposed to each other, while the first non-groove regions 2′ of the first parent member 1a and the first non-protrusion regions 5′ of the second parent member 1b are opposed to each other.

Then, the second parent member 1b is fitted to the first parent member 1a, and contact junctions are formed thereby. Then, as shown in FIG. 138, friction stir welding is performed along the contact junctions to form weld zones w. Each of the weld zones w is formed to remove at least a part of a horizontal interface between each of the first fluid holes 4a and each of the second fluid holes 4b.

In this case, each of the weld zones w may be formed larger in width than each of first grooves 2 of the first parent member 1a and each of first protrusions 5 of the second parent member 1b. In addition, each of the weld zones w may be formed such that the depth thereof reaches a position below a horizontal interface between each of the first hollow channels 201 and each of the first fluid holes 4a, without exceeding the height of the each of the first protrusions 5 of the second parent member 1b. This prevents the problem that particles in the weld zones w may be introduced into the first hollow channels 201 through non-weld regions.

Each of the weld zones w may be formed with the width and depth as above. The range of each of the weld zones W may include left and right contact junctions between each of the first grooves and each of the first protrusions. Due to this, each of the weld zones w may remove at least a part of each of left and right interfaces between each of the first grooves 2 of the first parent member 1a and each of the first protrusions 5 of the second parent member 1b. In addition, at least a part of the horizontal interface between each of the first hollow channels 201 and each of the first fluid holes 4a may be removed.

After the parent members 1 are welded by friction stir welding, a process of planarizing the weld zones w may be performed. At least a part of each of the weld zones w may be planarized.

As shown in FIG. 13C-1, planarizing may be performed at a position above horizontal interfaces between the parent members 1, the position being indicated by a dotted line. In other words, planarizing may be performed above the horizontal interfaces between the parent members 1.

Then, at least two first fluid holes 4a may be formed between each of the first hollow channels 201 by vertically passing through the parent members 1. In addition, the second fluid holes 4b may be formed by passing through the lower portions of the first parent member 1a, in communication with the first hollow channels 201. In this case, the second fluid holes 4b may be formed in any step after the formation of the first hollow channels 201.

Alternatively, as shown in FIG. 13C-2, planarizing may be performed at a position below the horizontal interfaces between the parent members 1, the position being indicated by a dotted line, within a range that does not deviate from the positions of the weld zones w, with respect to a downward direction on the drawings. In other words, planarizing may be performed below the horizontal interfaces between the parent members 1. A planarizing surface along which planarizing is performed may be located between the depth of the weld zones w and the horizontal interfaces. Then, at least two first fluid holes 4a may be formed between each of the first hollow channels 201 by vertically passing through the parent members 1. In addition, the second fluid holes 4b may be formed by passing through the lower portions of the first parent member 1a, in communication with the first hollow channels 201. As a result, a joined component 100′ having a shape as shown in FIG. 13D-2 may be obtained. The joined component 100′ manufactured as described above may respectively supply different process fluids separately through the first and second fluid holes 4a and 4b.

In FIG. 13D-1, horizontal interfaces exist between the first fluid holes 4a and the second fluid holes 4b.

On the contrary, in the structure of FIG. 13D-2, unlike FIG. 13D-1, no horizontal interface exists between the first fluid holes 4a and the second fluid holes 4b. As a result, it is possible to prevent the problem of movement and mixing of process fluids that may occur at horizontal interfaces. In addition, it is possible to prevent the problem of particle introduction that may occur at horizontal interfaces.

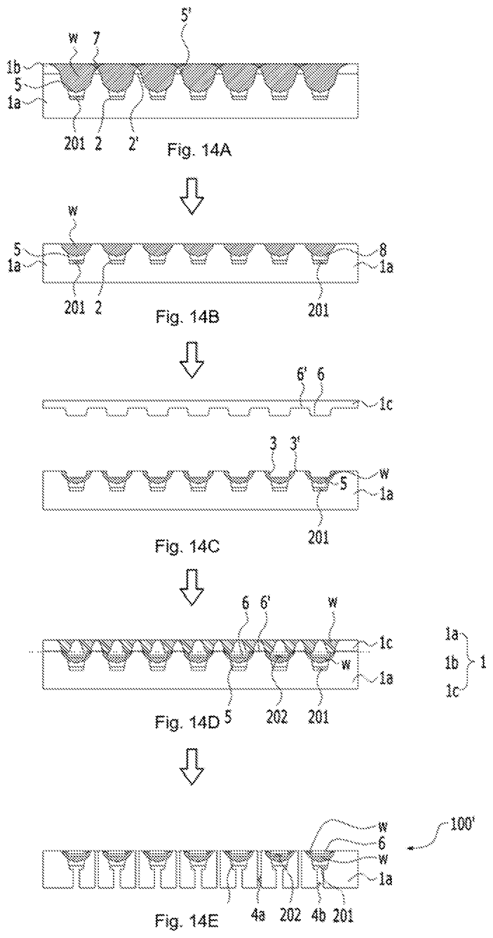

FIGS. 14A to 14E are views schematically showing a manufacturing process of a joined component 100′ according to a fourth modification of the second embodiment of the present invention. The joined component 100′ of the fourth modification differs from the second embodiment in that the number of parent members 1 and the shape of a portion of the parent members 1 are different, while first and second hollow channels 201 and 202 are formed inside the joined component 100′.

In the fourth modification, similarly to the second embodiment, a second parent member 1b is stacked on a top surface of a first parent member 1a. However, in addition, a third parent member 1c is stacked on a top surface of the second parent member 1b. The third parent member 1c includes second protrusion regions where second protrusions 6 are formed and second non-protrusion regions 6′ where second protrusions 6 are not formed. In this case, the shape of the parent members 1 and the form in which the parent members 1 are stacked are described as an example only, and are not limited thereto.

The joined component 100′ of the fourth modification includes the first parent member 1a, the second parent member 1b, and the third parent member 1c. In addition, first fluid holes 4a providing passages through which a first process fluid passes, and second fluid holes 4b providing passages through which a second process fluid passes may be provided. In addition, first hollow channels 201 formed in communication with the second fluid holes 4b, and second hollow channels 202 having a temperature control means may be provided.

When at least three parent members 1 are provided and these parent members 1 are stacked on top of each other and welded by friction stir welding as in the joined component 100′ of the fourth modification, at least two parent members 1 (for example, the first and second parent members 1a and 1b) are first welded by friction stir welding. Then, a remaining one of the parent members 1 (for example, the third parent member 1c) may be welded by friction stir welding to the welded parent members 1a and 1b. In this case, at least two parent members 1a and 1b to be first welded by friction stir welding are not limited to the above description. In other words, among at least three parent members 1, at least two parent members are first welded by friction stir welding and then a remaining one parent member is welded by friction stir welding to the welded parent members. Hereinafter, a description is given of an example in which the first and second parent members 1a and 1b are first welded by friction stir welding, and then the third parent member 1c is welded by friction stir welding to the welded first and second parent members 1a and 1b.

First, as shown in FIG. 14A, the second parent member 1b is fitted to the first parent member 1a. Contact junctions are formed thereby. Friction stir welding is performed along the contact junctions to form weld zones w. In this case, in the joined component 100′ of the fourth modification, the interval between the first hollow channels 201 may be relatively small. This may result in formation of an overlap portion 7 in which adjacent weld zones w overlap each other. The joined component 100′ of the fourth modification is only an example, and thus the overlap portion 7 may not be formed.

The first parent member 1a and the second parent member 1b are welded by friction stir welding. The weld zones w are formed thereby. Then, planarizing may be performed at the same position as a dotted line shown in FIG. 14A. In other words, the dotted line may indicate the position of a planarizing surface along which planarizing is performed.

Planarizing may be performed above horizontal interfaces between the parent members 1. Alternatively, as shown in FIG. 14A, planarizing may be performed below the horizontal interfaces between the parent members 1. As a result, the first and second parent members 1a and 1b welded by friction stir welding may have a shape as shown in FIG. 14B.

As shown in FIG. 14B, the first and second parent members 1a and 1b welded by friction stir welding may have a shape in which interfaces between the first and second parent members 1a and 1b are removed, with each of the weld zones w existing on at least a part of each of the contact junctions.

After the first and second parent members 1a and 1b are welded by friction stir welding, at least a part of each of the weld zones w of may be planarized. Due to this, horizontal interfaces between the first and second parent members 1a and 1b may be removed. The planarized first and second parent members 1a and 1b may have a shape as shown in FIG. 14B in which at least a part of each of the weld zones w and at least a part of each of first protrusions 5 of the second parent member 1b exist at the first parent member 1a. In addition, the first hollow channels 201 formed by fitting the first and second parent members 1a and 1b may exist.

In the first hollow channels 201, introduction of particles that may move along the interfaces between the parent members 1a and 1b is prevented by the weld zones w. This prevents particles from being introduced into the second fluid holes 4b formed in communication with the first hollow channels 201 by passing through the lower portions of the first parent member 1a.

Then, as shown in FIG. 14C, a second groove 3 may be formed in at least a part of each of the weld zones w planarized. The second groove 3 may be formed in at least a part of the weld zone w, within a range of the weld zone w. In region where the second grooves 2b are not formed, second non-groove regions 3′ may be formed. The second groove 2b formed in at least a part of each of the weld zones w may be located at a position corresponding to each of the second protrusions 6 of the third parent member 1c.

Then, as shown in FIG. 14C, the third parent member 1c is fitted. In detail, each of the second protrusions 6 of the third parent members 1c may be fitted into the second groove 2b formed in at least a part of each of the weld zones w. This results in formation the second hollow channels 202.

Each of the second hollow channels 202 formed by the second groove 2b formed within the range of each of the weld zones w may have a shape surrounded by at least a part of the weld zone w. Each of the second hollow channels 202 may include a temperature control means provided therein. In the second hollow channels 202, introduction of particles that may move along the interfaces between the parent members 1a and 1b is prevented by the weld zones w. As a result, it is possible to prevent the problem that a functional error of the temperature control means may occur due to particle introduction.

Then, as shown in FIG. 14D, friction stir welding may be performed along contact junctions formed when each of the second protrusions 6 of the third parent member 1c are fitted into each of the second grooves 3. In this case, in FIG. 14D, friction stir welding is performed along a left contact junction (on the drawings) formed on at least a part of a left interface between the second protrusion and the second groove and along a right contact junction (on the drawings) formed on at least a part of a right interface between the second protrusion and the second groove, such that a weld zone w is formed on each of the left and right contact junctions. However, the present invention is not limited thereto. The weld zones w may be formed as one weld zone w having a range within which the left and right contact junctions are included. Herein, the one weld zone W may be larger in width than the second protrusion 6 of the third parent member 1c and than the second groove 3.

As shown in FIG. 14D, each of the weld zones w may be formed on each of the left and right contact junctions formed on at least a part of each of the left and right interfaces. This results in formation of non-weld areas. The non-weld areas are formed between left and right contact surfaces of the second groove 3 of each of the weld zones w and left and right contact surfaces (on the drawings) of each of the second protrusions 6 of the third parent member 1c. Due to the non-weld areas, the area in which the temperature control means provided in the second hollow channels 202 can move inside the second hollow channels 202 increases. This ensures that the temperature control effect of the joined component 100′ is further improved. The non-weld areas are formed at positions below the weld zones W. Therefore, it is ensured that introduction of particles due to friction stir welding and introduction of negative particles are prevented by the weld zones w.

As shown in FIG. 14D, after the second protrusions 6 of the third parent member 1c is fitted into the second grooves 3 and welded by friction stir welding, secondary planarizing may be performed.

When a process shown in FIG. 14B is referred to as primary planarizing, secondary planarizing is performed as shown in FIG. 14D. The second parent member 1c is welded by friction stir welding to the first and second parent members 1a and 1b primarily planarized. The weld zones w formed thereby are secondarily planarized. The secondary planarizing may be performed at the same position as a dotted line shown in FIG. 14D. In other words, the dotted line may indicate the position of a planarizing surface along which planarizing is performed. Planarizing may be performed above the horizontal interfaces between the parent members 1. Alternatively, as shown in FIG. 14D, planarizing may be performed below the horizontal interfaces between the parent members 1. Due to this, interfaces between the first and third parent members 1a and 1c may be removed. As a result, it is possible to prevent the problem of particle generation that may occur at horizontal interfaces.

Then, as shown in FIG. 14E, the first fluid holes 4a may be formed between the first hollow channels 201 by vertically passing through the parent members 1. In addition, the second fluid holes 4b may be formed by passing through the lower portions of the first parent member 1a, in communication with the first hollow channels 201. In this case, the second fluid holes 4b may be formed in any step after the formation of the first hollow channels 201.

The joined component 100′ of the fourth modification manufactured as described above may respectively supply different process fluids separately through the first and second fluid holes 4a and 4b. In addition, the provision of the temperature control means ensures that temperature uniformity of a product itself is secured.

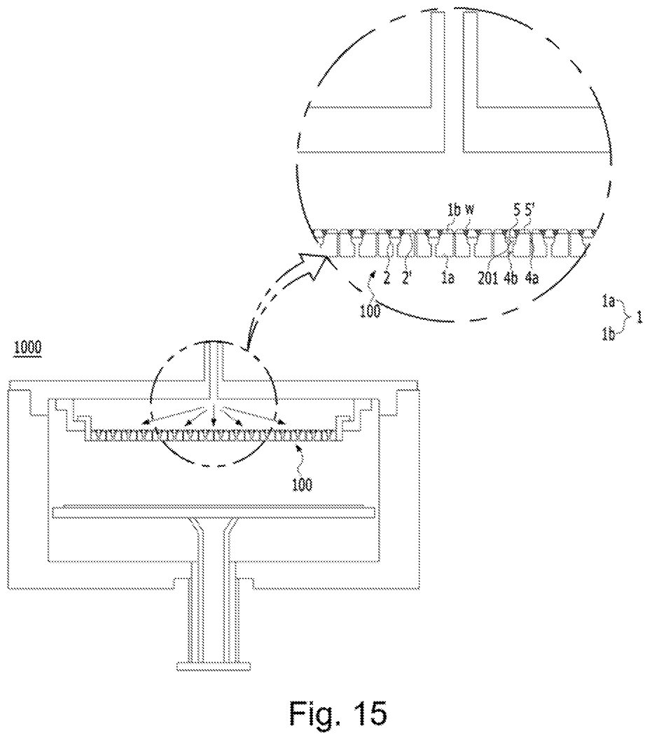

FIG. 15 is a view schematically showing semiconductor manufacturing process equipment or display manufacturing process equipment 1000 including the second embodiment of the present invention. In FIG. 15, the joined component 100′ provided in the semiconductor manufacturing process equipment or display manufacturing process equipment 1000 is the joined component 100′ of the second embodiment. However, the present invention is not limited thereto, and the joined components 100′ of the first to fourth modifications may be provided. In addition, the joined components 100 of the first embodiment and the modification of the first embodiment may be provided.

The semiconductor manufacturing process equipment 1000 includes etching equipment, cleaning equipment, heat treatment equipment, ion implantation equipment, sputtering equipment, CVD equipment, or the like.

The display manufacturing process equipment 1000 includes etching equipment, cleaning equipment, heat treatment equipment, ion implantation equipment, sputtering equipment, CVD equipment, or the like.

The semiconductor manufacturing process equipment or display manufacturing process equipment 1000 shown in FIG. 15 may include the joined component 100′ of the second embodiment. Alternatively, the joined components 100′ of the first to fourth modifications of the second embodiment may be provided. The semiconductor manufacturing process equipment or display manufacturing process equipment 1000 may perform the same function as the semiconductor manufacturing process equipment or display manufacturing process equipment 1000 including the joined component 100 of the first embodiment described above with reference to FIG. 6. In addition, the effects according thereto may be the same. Therefore, duplicate descriptions will be omitted, but will be substituted by the above description described with reference to FIG. 6.

As described above, in the joined components 100 and 100′ according to the embodiments and the modifications of the present invention, each of the weld zones w formed by friction stir welding is formed to remove at a least a part of the horizontal interface between each of the first fluid holes 4a and each of the second fluid holes 4b. The weld zones w prevent different process fluids passing through the first and second fluid holes 4a and 4b from moving along horizontal interfaces. This prevents the problem that different process fluids may react inside the joined components 100 and 100′ before being sprayed, causing an undesired chemical reaction to occur. In the joined components 100 and 100′, adverse interaction which may occur between separate fluid holes is prevented by the weld zones w, thus ensuring more effective spraying of the process fluids. Furthermore, in the joined components 100 and 100′ according to the present invention, no weld joint or braze joint 20 of the related art exists at the inner surfaces of the fluid holes. Therefore, it is ensured that the risk of corrosion on the inner surfaces of the fluid holes is low. It is also ensured that particle generation due to corrosion is reduced. As a result, there is an effect of reducing the rate of defective wafers that may occur due to spraying of process fluids in which particles are entrained.

Although the exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A joined component through which a process fluid passes in a semiconductor manufacturing process or a display manufacturing process, the joined component being formed by welding at least two parent members by friction stir welding, and comprising:
a first fluid hole vertically passing through the parent members and providing a passage through which a first process fluid passes; and
a second fluid hole being in communication with a first hollow channel formed inside the joined component, and providing a passage through which a second process fluid passes,
wherein a weld zone formed by friction stir welding is formed to remove at least a part of a horizontal interface between the first and second fluid holes, and
the first process fluid is introduced into the first fluid hole and the second process fluid is introduced into the second fluid hole, such that the first and second fluid holes respectively supply different process fluids separately.

2. A joined component through which a process fluid passes in a semiconductor manufacturing process or a display manufacturing process, the joined component being formed by welding at least two parent members by friction stir welding, and comprising:
a first fluid hole vertically passing through an overlap portion where weld zones formed by friction stir welding at least partially overlap each other, and providing a passage through which a first process fluid passes; and
a second fluid hole being in communication with a first hollow channel formed inside the joined component, and providing a passage through, which a second process fluid passes,
wherein a weld zone formed by friction stir welding is formed to remove at least a part of a horizontal interface between the first and second fluid holes, and
the first process fluid is introduced into the first fluid hole and the second process fluid is introduced into the second fluid hole, such that the first and second fluid holes respectively supply different process fluids separately.

3. A joined component through which a process fluid passes in a semiconductor manufacturing process or a display manufacturing process, the joined component being formed by welding at least two parent members by friction stir welding, and comprising:
a first fluid hole passing through the parent members in a weld zone formed by friction stir welding, and providing a passage through which a first process fluid passes; and
a second fluid hole being in communication with a first hollow channel formed inside the joined component, and providing a passage through which a second process fluid passes.

4. The joined component of any one of claim 1, further comprising:
a second hollow channel formed inside the joined component and including a temperature control means.

5. The joined component of claim 4, wherein the temperature control means is a fluid or a heat wire.

6. The joined component of any one of claim 1, wherein the joined component is provided in etching equipment, cleaning equipment, heat treatment equipment, ion implantation equipment, sputtering equipment, or CVD equipment.

7. The joined component of any one of claim 1, wherein the first fluid hole is provided as multiple first fluid holes that are arranged at a spaced apart relationship at an interval of equal to or greater than 3 mm to equal to or less than 15 mm, and the second fluid hole is provided as multiple second fluid holes that are arranged at a spaced apart relationship at an interval of equal to or greater than 3 mm to equal to or less than 15 mm.
